(19) United States
(12) Patent Application Publication
(10) Pub. No.: US 2019/0047134 A1
(43) Pub. Date: Feb. 14, 2019

(54) Storage Device

(71) Applicant: Wheelfloat, Inc., Southlake, TX (US)

(72) Inventors: Jonathan D. Snook, Southlake, TX (US); Thomas G. Fulbright, Keller, TX (US)

(73) Assignee: Wheelfloat, Inc., Southlake, TX (US)

(21) Appl. No.: 16/134,808

(22) Filed: Sep. 18, 2018

Related U.S. Application Data
(63) Continuation-in-part of application No. 15/134,139, filed on Apr. 20, 2016, now Pat. No. 10,076,835.
(60) Provisional application No. 62/150,765, filed on Apr. 21, 2015.

(51) Int. Cl. B25F 5/02; B25G 1/08; B25B 15/04; B25B 21/00; B25B 23/00

(52) U.S. Cl. CPC B25F 5/029; B25G 1/085; B25B 23/0035; B25B 21/00; B25B 15/04

(57) ABSTRACT

A storage device includes at least one cartridge defining a cavity for receiving at least one storage item. A receiver defines at least one cell for receiving the at least one cartridge, and a passageway extends longitudinally along the center of the receiver to an opening defined in an external surface of the receiver. Springs are employed for biasing the at least one cartridge in a first position in the at least one cell wherein the cavity is not aligned with the passageway, or in a second position in the at least one cell wherein the cavity is aligned with the passageway. In one application, the storage device is adapted for storing bits in a multi-bit screwdriver.

### CROSS-REFERENCE TO RELATED APPLICATIONS

This application is a continuation-in-part of U.S. Pat. No. 10,076,835, formerly co-pending patent application Ser. No. 15/134,139, filed on Apr. 20, 2016, and issued on Sep. 18, 2018, which patent claims the benefit of U.S. Provisional Application No. 62/150,765, filed Apr. 21, 2015, which patent and application are hereby incorporated herein by reference, in their entirety.

### TECHNICAL FIELD

The invention relates generally to a storage device and, more particularly, to a storage device that enables a large variety of different items of similar size to be stored in a portable container and to be readily selectable for retrieval and use.

### BACKGROUND

It is common to have a large number of small items that must be stored in some manner. Such small items may include, by way of example, but not limitation, artist charcoal/pencils, children's crayons, drill bits, taps (for cutting threads), bobbins for sewing, spices, gauge pins, screwdriver bits, fishing weights, and the like. Often, small items are all stored together in a large bin, but it then becomes difficult to identify and retrieve any particular item. In other instances, a small box or drawer will be devoted to each item, but that often results in an inefficient use of space.

A screwdriver represents a particular case in point wherein a person may need a number of different screwdrivers to perform a task. This is particularly problematic, time consuming, and even dangerous, when such person is working on a ladder and must continually go up and down the ladder to fetch different screwdrivers. For such cases, screwdrivers are available which hold a number of different bits selectable by a user; such screwdrivers are referred to as multi-bit screwdrivers. There are, however, a number of drawbacks associated with “multi-bit” screwdrivers. The most common drawback is that such screwdrivers typically require two hands to change a bit, which can be dangerous when, for example, a user is standing atop a high ladder. Another common drawback is that the number of bits is very limited, such as six or even fewer bits. A still further drawback is that bits can be dropped or lost during handling.

In view of the foregoing, there is a need for a storage device that enables a large variety of different items of similar size to be readily stored and retrieved in a portable container and to be readily selectable for use. It would be desirable in one application for such a storage device to be adapted to a multi-bit screwdriver in a way which would allow the screwdriver to be operable with a single hand, to carry a sufficient number of bits to be useful in a large number of applications, and wherein the bits are secured and loaded within the screwdriver.

### SUMMARY

The present invention, accordingly, provides a storage device for managing the storage and retrieval of items for delivery to a point of use. Accordingly, the storage device includes at least one cartridge defining a cavity for receiving at least one storage item. A receiver defines at least one cell for receiving the at least one cartridge, and a passageway extending longitudinally along the center of the receiver to an opening in an external surface of the receiver. In a first embodiment, magnets are secured to the receiver and the at least one cartridge for magnetically biasing the at least one cartridge in a first position in the at least one cell wherein the cavity is not aligned with the passageway, or in a second position in the at least one cell wherein the cavity is aligned with the passageway.

In a second embodiment, one of one or more springs (cut, e.g., from a sheet of Mylar®) extends through a slot of a respective cartridge of the one or more cartridges, and is positioned and restrained between two stops. Each spring of the one or more springs is sized to bow between the two stops and bias each of the one or more cartridges in a first position in the one or more cells wherein the cavity is not aligned with the passageway, or in a second position in the one or more cells wherein the cavity is aligned with the passageway.

In one application of the invention, the storage device is configured as a portion of a handle in a multi-bit screwdriver having a tubular shaft extending from the handle. The screwdriver is configured for enabling a user to select a bit and pass it through the handle and tubular shaft to an end of the shaft for use in tightening and loosening fasteners, such as screws. A ratchet mechanism is preferably positioned between the handle and the shaft for selectively controlling the direction of rotation in which the handle turns the shaft and bit.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a perspective view of a storage device embodying features of the present invention;

FIG. 1A is a perspective view of a screwdriver embodying features of the storage device of FIG. 1 and of the present invention;

FIGS. 2A-2D exemplify a bit adapted for use with the screwdriver of FIG. 1A;

FIG. 3A is a cross-section of the screwdriver of the invention taken along line 3-3 of FIG. 1A;

FIG. 3B is a cross-section of the screwdriver of the invention taken along line 3B-3B of FIG. 3A;

FIG. 3C is a cross-section of the screwdriver of the invention taken along line 3C-3C of FIG. 3A;

FIG. 3D is a cross-section of the screwdriver of the invention taken along line 3-3 of FIG. 1A;

FIGS. 4-7 exemplify various views of a cartridge adapted for holding a bit for use in a screwdriver of the invention;

FIGS. 8A-8D exemplify various states of cartridges positioned in a handle and taken along line 8-8 of FIG. 3D;

FIG. 9A exemplifies a shaft of a screwdriver of the invention;

FIG. 9B shows a cross-section of the shaft taken along line 9B-9B of FIG. 9A;

FIG. 9C shows a cross-section of the shaft taken along line 9C-9C of FIG. 9A;

FIG. 10A exemplifies a shaft of a screwdriver of the invention having a bit moving upwardly inside a barrel of the shaft;

FIG. 10B shows a cross-section of the shaft taken along line 10B-10B of FIG. 10A;

FIG. 11A exemplifies a shaft of a screwdriver of the invention having a bit moving upwardly inside a barrel of the shaft;

FIG. 11B shows a cross-section of the shaft taken along line 11B-11B of FIG. 11A;

FIG. 12A exemplifies a shaft of a screwdriver of the invention having a bit moving upwardly inside a barrel of the shaft;

FIG. 12B shows a cross-section of the shaft taken along line 12B-12B of FIG. 12A;

FIG. 13 exemplifies a shaft of a screwdriver of the invention having a bit moving upwardly inside a barrel of the shaft;

FIG. 14A exemplifies a shaft of a screwdriver of the invention having a bit in position for use;

FIG. 14B shows a cross-section of the shaft taken along line 14B-14B of FIG. 14A;

FIG. 15 exemplifies a shaft of a screwdriver of the invention having a bit moving downwardly inside a barrel of the shaft;

FIG. 16 is a perspective view exemplifying a screwdriver of an alternate embodiment of the invention;

FIG. 17 is a perspective view of the screwdriver of FIG. 16, showing a lower end of the screwdriver;

FIG. 18 is a cross-sectional view of the screwdriver of FIG. 16 taken along line 18-18 of FIG. 16;

FIGS. 19 and 20 are perspective views of a further alternate embodiment of the invention embodying principles of the present invention;

FIG. 21 exemplifies a receiver of the screwdriver without an outer cover;

FIG. 22 exemplifies an outer cover of the screwdriver without a receiver;

FIG. 23 exemplifies a side view of the screwdriver in a locked position for operation;

FIG. 24 is a bottom view of the screwdriver of FIG. 23 taken along the line 24-24 of FIG. 23;

FIG. 25 exemplifies a side view of the screwdriver in an unlocked position for changing a bit;

FIG. 26 is a bottom view of the screwdriver of FIG. 25 taken along the line 26-26 of FIG. 25;

FIG. 27 exemplifies how the embodiment of FIGS. 19 and 20 may be mounted to a chuck of a power drill;

FIG. 28 exemplifies how the embodiment of FIGS. 19 and 20 may be permanently mounted to a power drill;

FIG. 29 is a perspective view of a still further alternate embodiment of the storage device embodying features of the present invention;

FIG. 30 is a perspective view of an alternate embodiment of a screwdriver embodying features of the storage device of FIG. 29 and further of the present invention;

FIG. 31 is a cross-section of the screwdriver of the invention taken along line 31-31 of FIG. 30;

FIG. 32 is a cross-section of the screwdriver of the invention of FIG. 31 with cartridges;

FIGS. 33-36 exemplify various views of an alternate embodiment of a cartridge adapted for holding a bit for use in a screwdriver of the invention;

FIGS. 37A-37D, taken along line 37-37 of FIG. 32, exemplify a sequence of states of the cartridges of FIGS. 33-36 for positioning a selected bit for use;

FIGS. 38A-38D, taken along line 37-37 of FIG. 32, exemplify a sequence of states of the cartridges of FIGS. 33-36 positioned in a handle for storing a bit;

FIG. 39 is a perspective view exemplifying a screwdriver of an alternate embodiment of the invention; and

FIG. 40 is a cross-sectional view of an alternate embodiment of a screwdriver embodying features of the invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein. Additionally, as used herein, the term “substantially” is to be construed as a term of approximation. Refer now to the drawings wherein like or similar elements are designated by the same reference numeral through the several views.

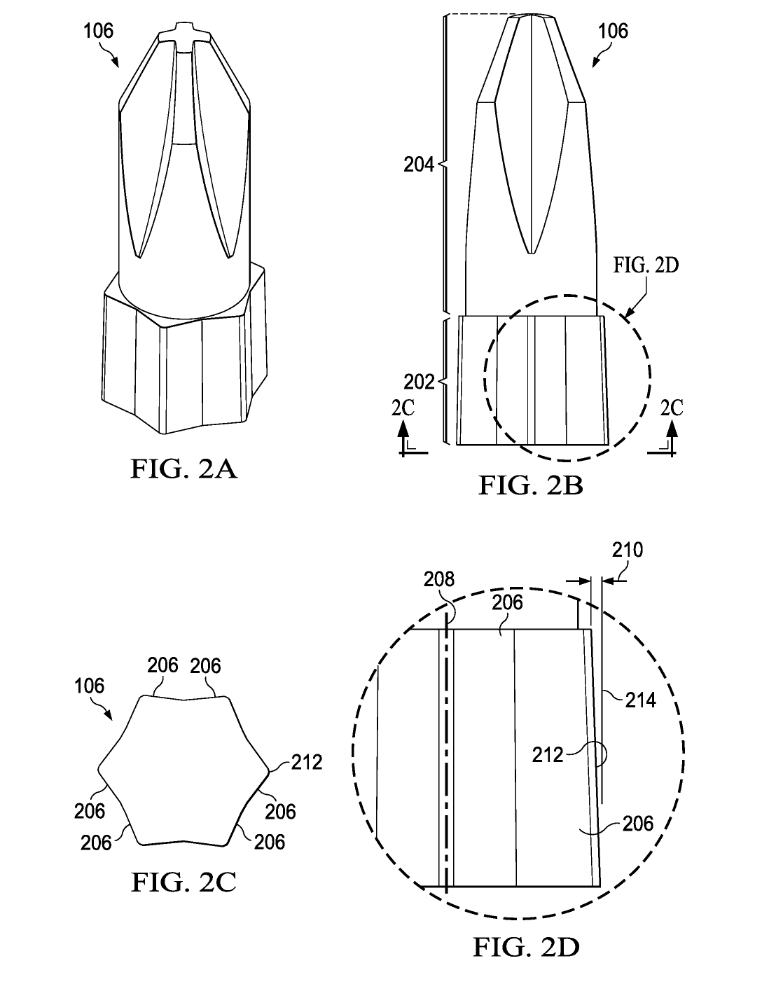

For purposes of definition, the term “bit” is used herein to signify any items desirable for storage, such as, by way of example, but not limitation, artist charcoal/pencils, children's crayons, drill bits, taps (for cutting threads), bobbins for sewing, spices, gauge pins, bits for a screwdriver, fishing weights, and the like. For purposes of illustration, bits will be depicted herein, by way of example, but not limitation, as a Phillips head bit in FIGS. 2A-2D, representative of any of the foregoing items desirable for storage. Terms such as “leftward,” “rightward,” “leftwardly,” and “rightwardly,” are relative terms as will be defined below with respect to respective drawings.

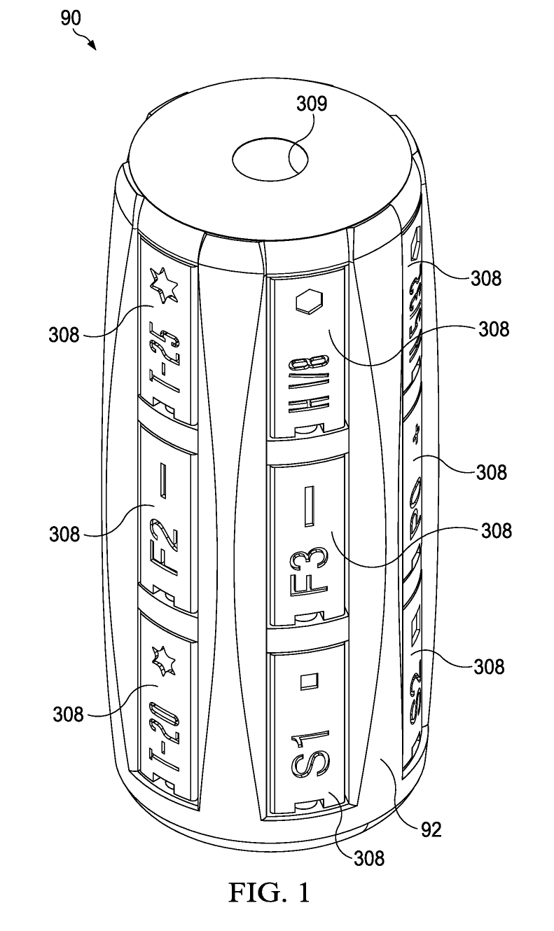

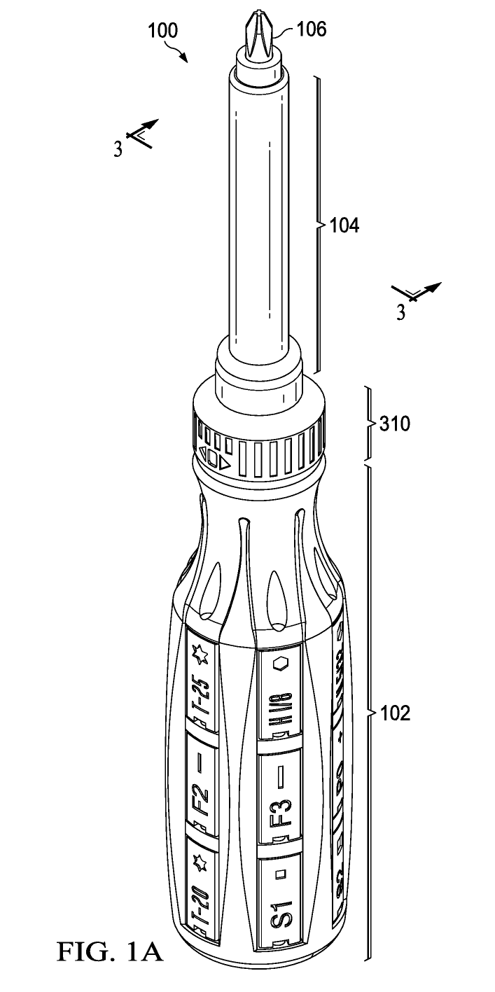

Referring to FIG. 1 of the drawings, the reference numeral 90 generally designates a storage device embodying features of the present invention for storing bits, as defined above. The storage device 90 includes a number of cartridges 308, each of which defines a cavity (not shown in FIG. 1) for storing a single storage item. The storage device 90 includes a receiver 92 that defines at least one cell (not shown in FIG. 1) for receiving the at least one cartridge 308, and a passageway (not shown in FIG. 1) extending longitudinally along the center of the receiver to an opening 309 defined in an external surface of the receiver for inserting items into the unit, and for retrieving items from the unit. The passageway facilitates passage of a selected storage item between a cartridge 308 cavity and the opening 309. In the interest of efficiency, the storage device 90 is described in further detail below with respect to one application relating to a multi-bit screwdriver.

Accordingly, in FIG. 1A of the drawings, the reference numeral 100 generally designates a multi-bit screwdriver embodying features of the present invention. Screwdriver 100 preferably includes a handle portion 102, a ratchet 310, a shaft portion 104, and a bit portion 106, all of which portions will be described in further detail below.

FIG. 2A is a perspective view exemplifying bit 106. FIG. 2B is a side view of bit of FIG. 2A, and as shown therein, bit 106 includes a base portion 202 and a head portion 204. Head portion 204 is depicted as a Phillips head, but may be of any suitable or desirable shape, such as a slotted (flat) head, square, hex socket, Allen, spanner head, spline drive, or the like. Base portion 202 preferably includes a number of generally concave sides or surfaces 206 arranged in any suitable shape, such as a hexagon or six-pointed star having six generally concave sides in a preferred embodiment, depicted in FIG. 2C, or in alternative embodiments, base portion 202 may define any of a number of different shapes, such as a hexagon, pentagon, octagon, or the like with sides 206 which may be flat, but which are preferably concave, or the like, having edges, such as depicted by reference numeral 212. FIG. 2D shows sides 206 of the base portion 202, and edge 212, preferably conically canted toward head portion 204 at an angle 210 from a line 214 parallel to a centerline 208 of bit 106. Angle 210 is preferably about 1°, but may vary from 0° to about 10° for reasons discussed below. Bit 106 is preferably made from substantially hard, non-magnetic material, such as high manganese steel alloy, stainless steel, or the like.

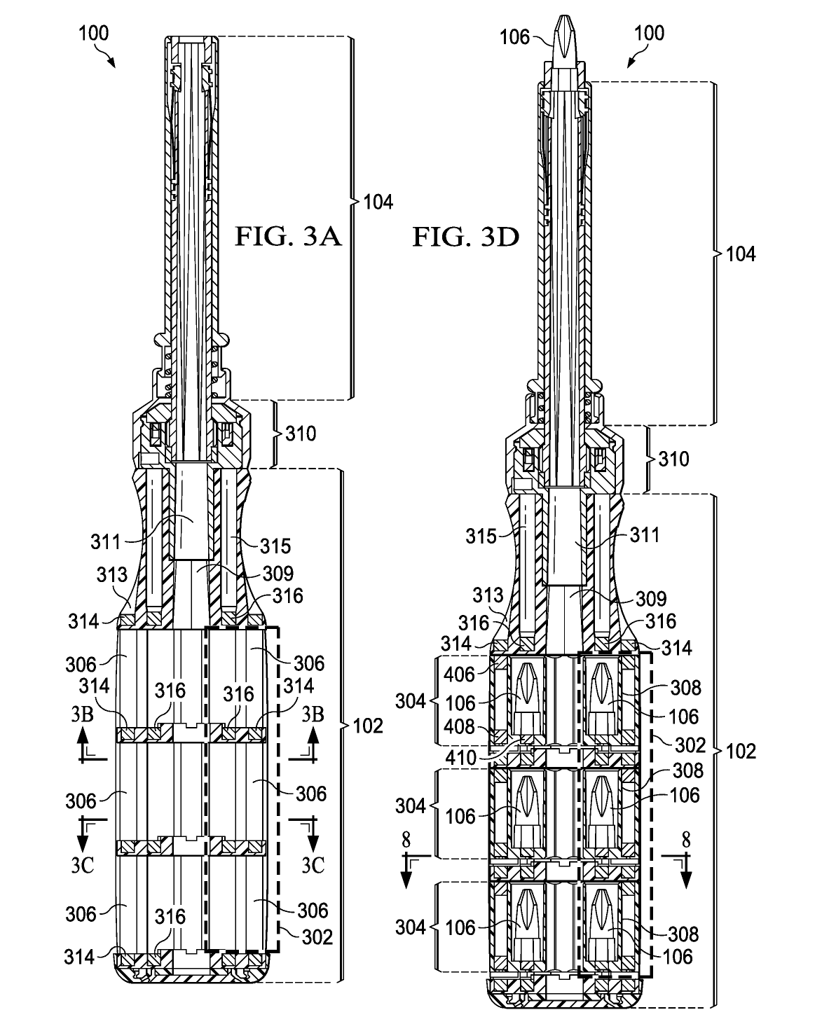

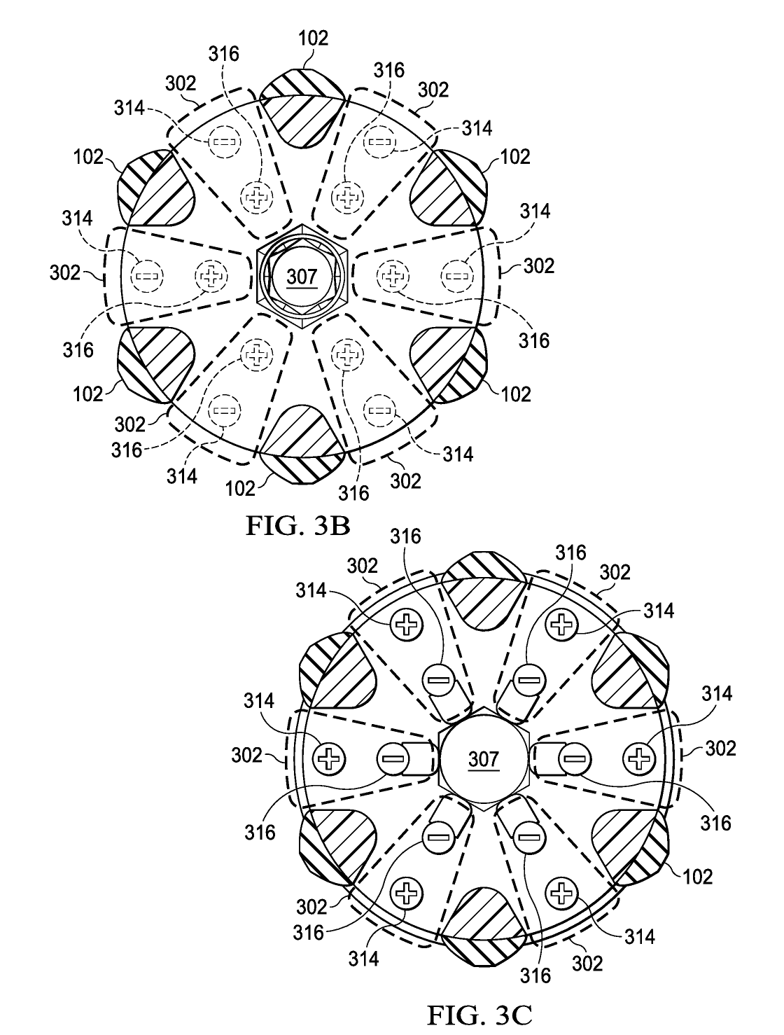

FIGS. 3A and 3D are cross-sections of screwdriver 100 taken along line 3-3 of FIG. 1A. Handle 102 preferably defines six columns 302, though more or less such columns may be so defined. Each column 302 includes at least one row 304 (three of which rows are exemplified in FIG. 3D), and each row 304 of each column 302 defines one respective cell 306 for holding one respective cartridge 308, discussed below. Screwdriver 100 preferably also includes a ratchet mechanism 310, which may comprise any conventional ratchet mechanism, but preferably a ratchet as taught in co-pending patent application Ser. No. 14/677,698, filed Apr. 2, 2015, and incorporated herein by reference in its entirety.

FIGS. 3B and 3C depict a view of upper and lower cell surfaces, respectively, of a row 304 of cells 306. As shown in FIG. 3C and in dashed outline in FIG. 3B, each upper and lower surface preferably includes two receiver magnets 314 and 316 embedded therein in each cell 306. The north and south polarities of the magnets are designated in the drawings by positive and negative signs (“+” and “−”), respectively. Magnets 314 and 316 are preferably oriented to have opposite polarities. While polarities of magnets 314 and 316 are depicted of particular polarities, polarities may be reversed so long as resultant magnetic interactions are consistent with interactions caused by polarities described herein.

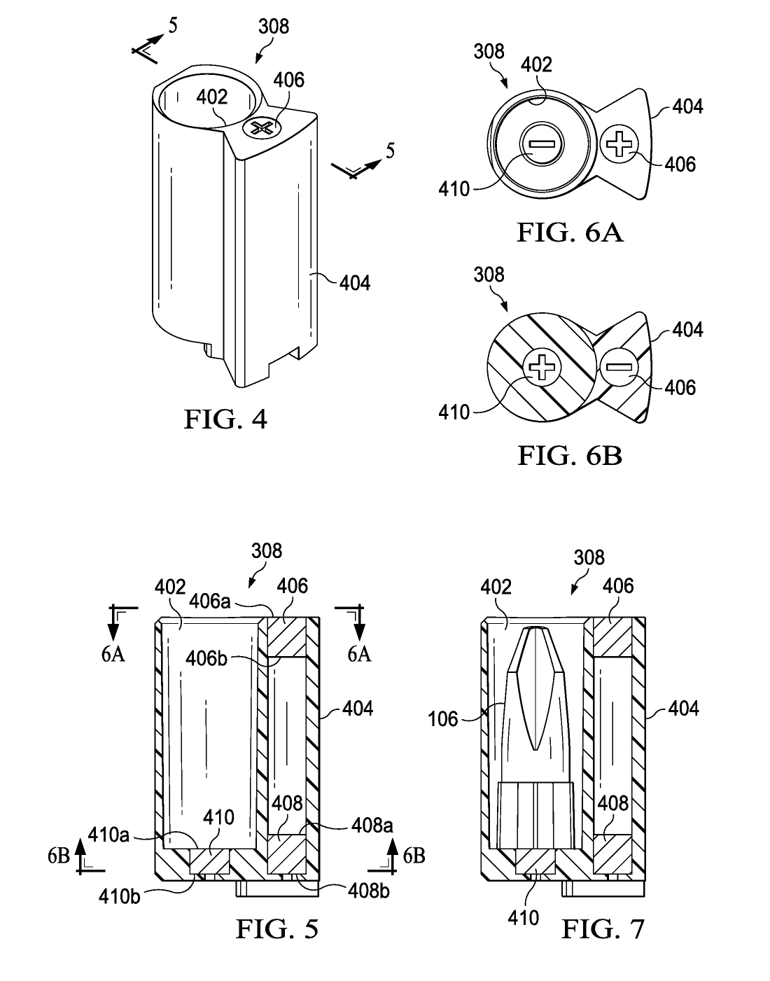

FIGS. 4-7 depict a cartridge 308 configured to receive and hold bit 106 in cell 306, and preferably fabricated from a non-magnetic material such as plastic, high manganese steel alloy, stainless steel, or the like. Cartridge 308 defines a cavity 402 for receiving bit 106 (FIG. 7), and a button 404. Cartridge 308 preferably includes three cartridge magnets, namely, a cavity magnet 410 positioned at the bottom of cavity 402, and upper and lower magnets 406 and 408 positioned in upper and lower portions of button 404. The polarity of magnets 406 and 408 is preferably oriented the same, and opposite that of magnet 410. As exemplified most clearly in FIG. 5, the positive or north ends of magnets 406, 408, and 410 is represented by ends 406a, 408a, and 410b respectively; thus, as viewed in FIGS. 5, 6A, and 6B, positive or north ends 406a and 408a of magnets 406 and 408 are oriented upwardly, and the positive or north end 410b of magnet 410 is oriented downwardly. Conversely, the negative or south ends of magnets 406, 408, and 410 is represented by ends 406b, 408b, and 410a respectively; thus, as viewed in FIGS. 5, 6A, and 6B, negative or south ends 406b and 408b of magnets 406 and 408 are oriented downwardly, and the negative or south end 410a of magnet 410 is oriented upwardly.

Referring back to FIG. 3D, as discussed above, screwdriver 100 includes handle 102, which includes a number of columns 302, each of which columns includes at least one row 304 (three of which rows are exemplified in FIG. 3D), and each row 304 of each column 302 defines one respective cell 306. As shown in FIG. 3D, a cartridge 308 is positioned in each cell 306. For purposes of illustration, each cartridge is shown holding a Phillips head bit, though typically, various bits, discussed above, would be stored in the cartridges. Screwdriver 100 further preferably includes a passageway 309 and a funnel 311 (with a lower opening slightly larger than an upper opening) for facilitating and directing the passage of bits between passageway 307 (FIGS. 3B, 3C) of handle 102 and shaft 104. Bores 313 and 315 are preferably formed for the purpose of facilitating placement of magnets 314 and 316, respectively, in the upper row of cells 306 of handle 102.

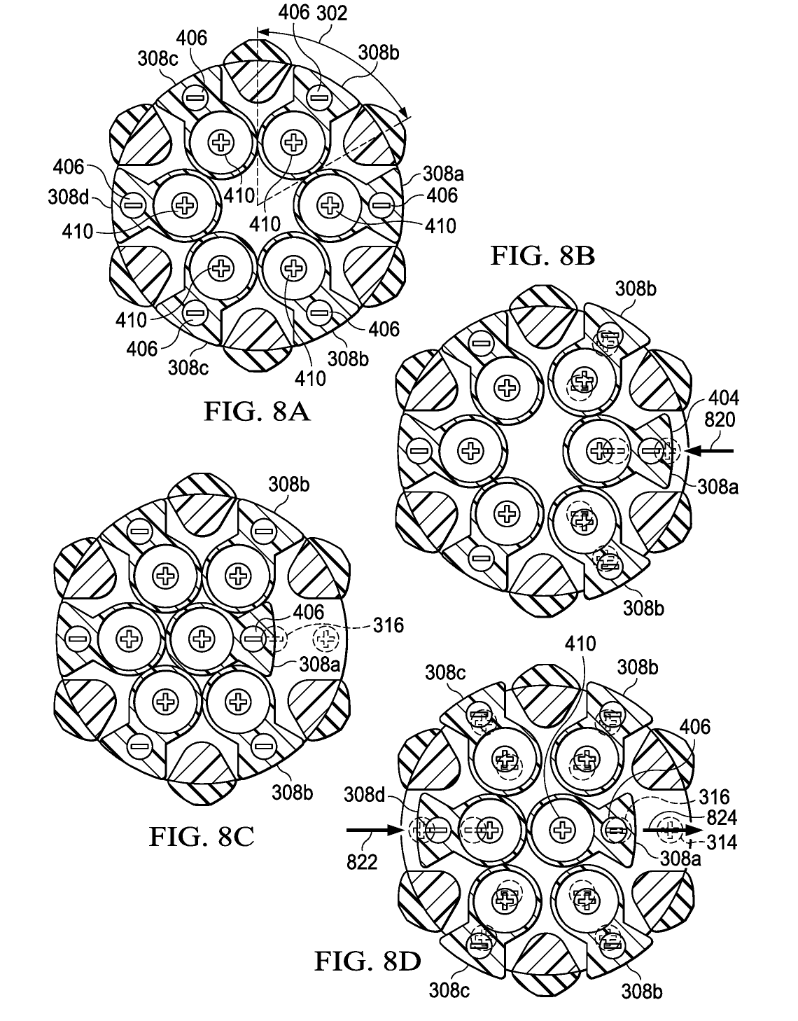

FIG. 8A depicts a cross section of one row 304 of handle 102 taken along line 8-8 of FIG. 3D. The row is exemplified in handle 102 having six columns 302, and hence, six cells 306 and six cartridges 308. For purposes of illustration of operation, letters are appended to cartridges 308 to distinguish them, one from another. FIGS. 8B-8D will be discussed further below with respect to operation of the screwdriver.

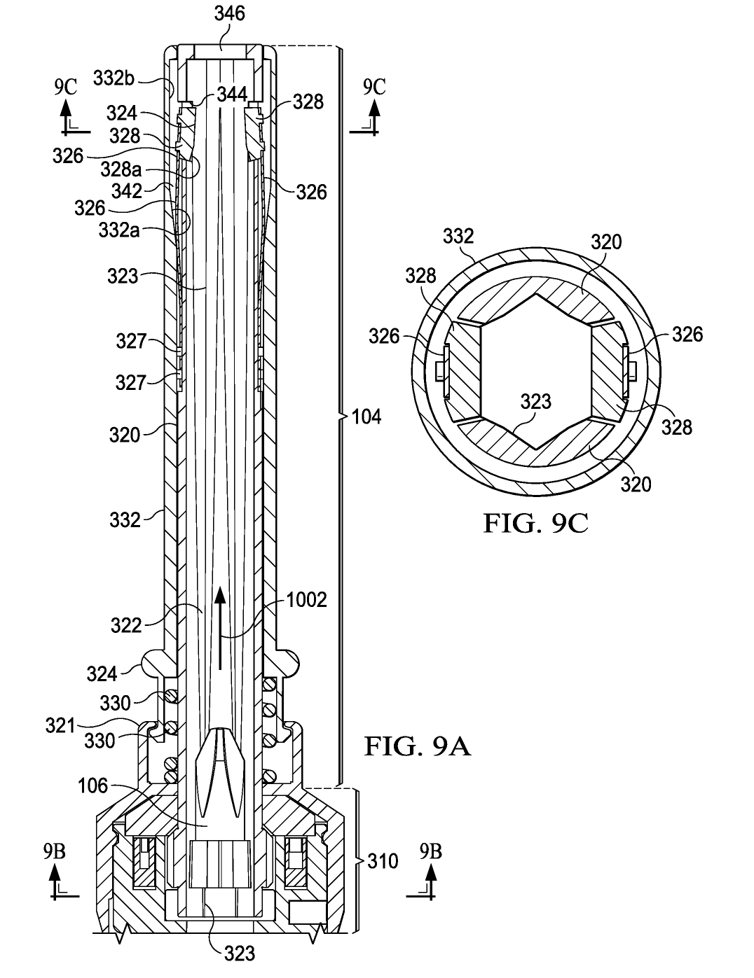

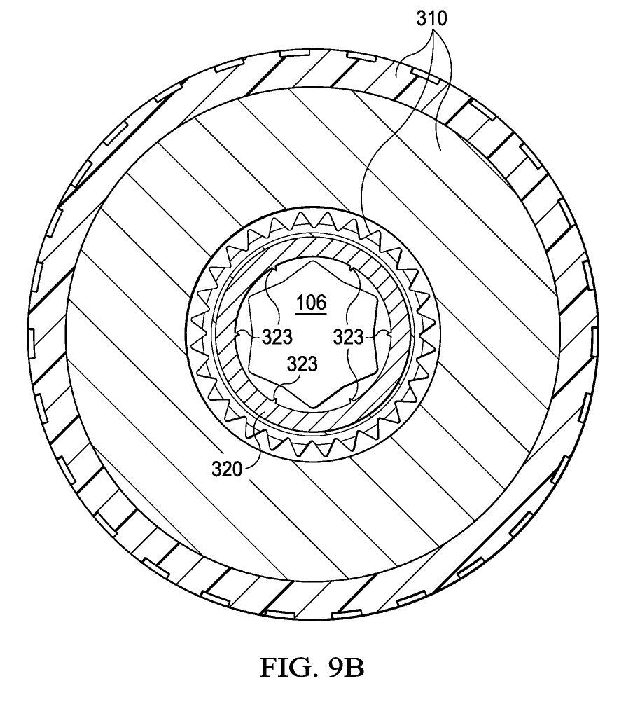

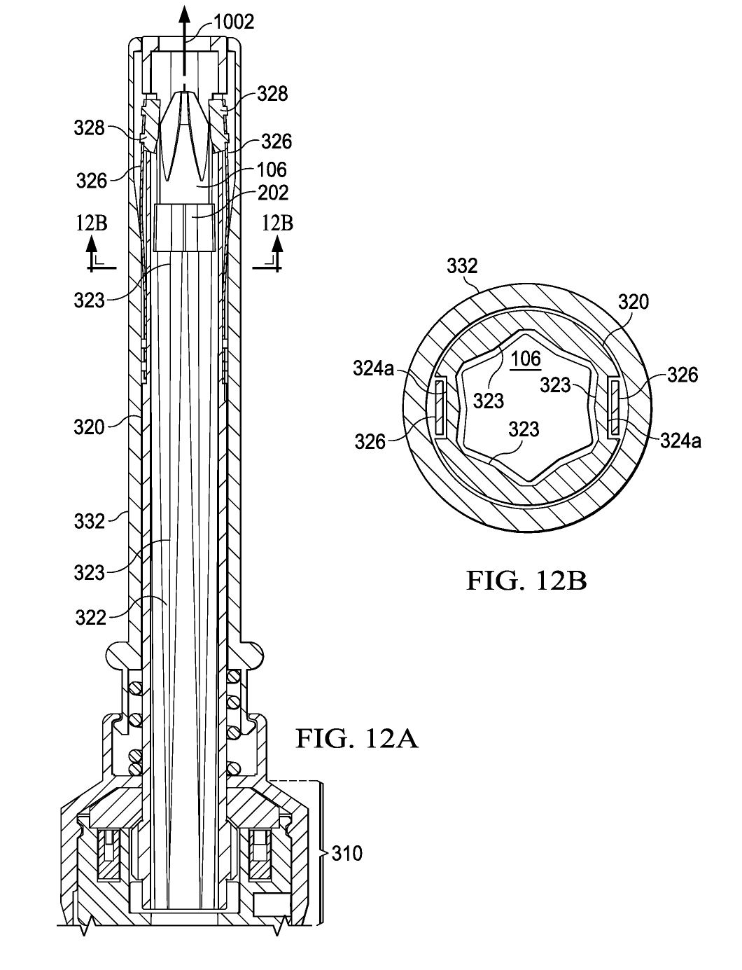

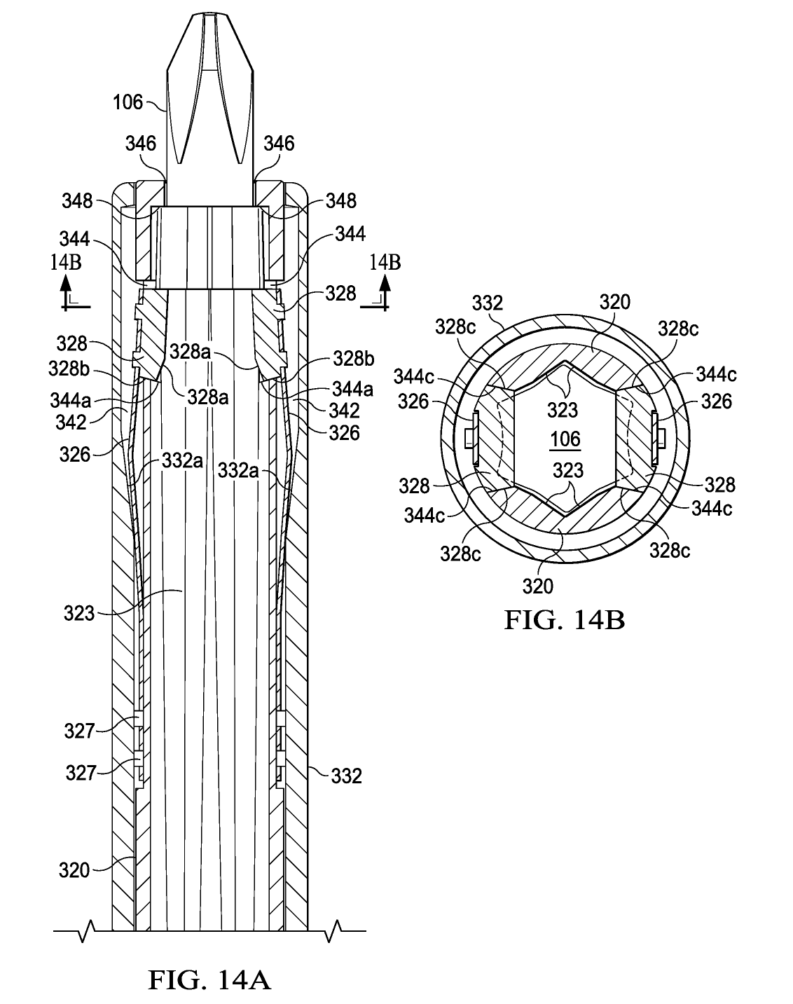

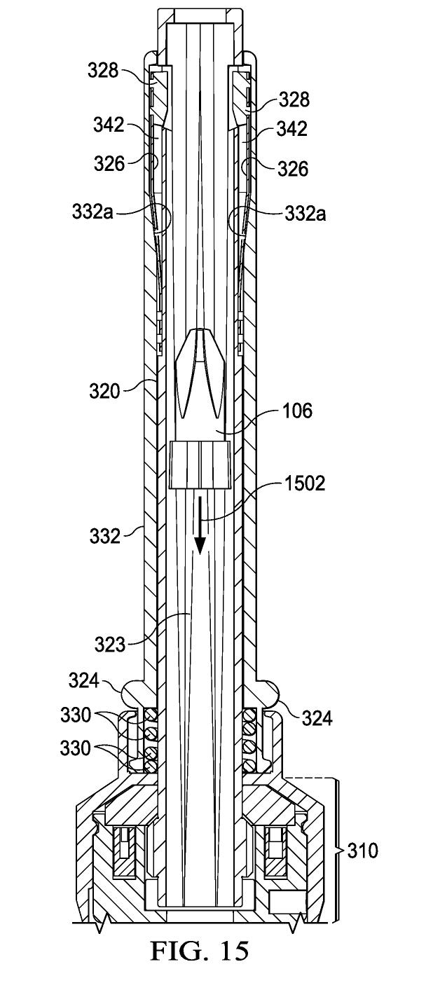

FIG. 9A depicts a cross-section of shaft 104 and ratchet mechanism 310 taken along line 3-3 of FIG. 1A. The shaft 104 includes a barrel 320 rotatably fixed to the ratchet mechanism 310 and handle 102. A sleeve 332 is slidably positioned about barrel 320, and restrained in axial movement by a catch 321. A spring 330 urges the sleeve against catch 321, and a finger pull 324 is positioned on the sleeve for enabling a user to use a finger (or alternatively a thumb) to pull the sleeve back against the bias of spring 330. The interior of barrel 320 is preferably configured with a number of lands 322 that are tapered so that the barrel interior has a substantially circular cross-section at a lower end (as viewed in FIG. 9A) which tapers, at an upper end (as viewed in FIG. 9A), to a substantially polygonal shape, preferably a generally hexagonal or six-pointed star shape having six generally convex sides as shown in FIGS. 12B and 14B and corresponding to the sides of the bit shown in FIG. 2C. The taper of lands 322 along the barrel are seen more clearly in FIGS. 9A-15, discussed below in connection with the operation of screwdriver 100. The number and shape of sides of the polygonal cross-section correspond to the number and shape of lands 322 of the barrel, which corresponds to the number and shape of sides of base 202 of bit 106. In a preferred embodiment, depicted in the figures, base 202 of bit 106 consists of six generally concave sides, as shown in FIG. 2C, and the barrel consists of six generally convex lands configured at the upper end to matingly engage the six generally concave sides 206 of base 202.

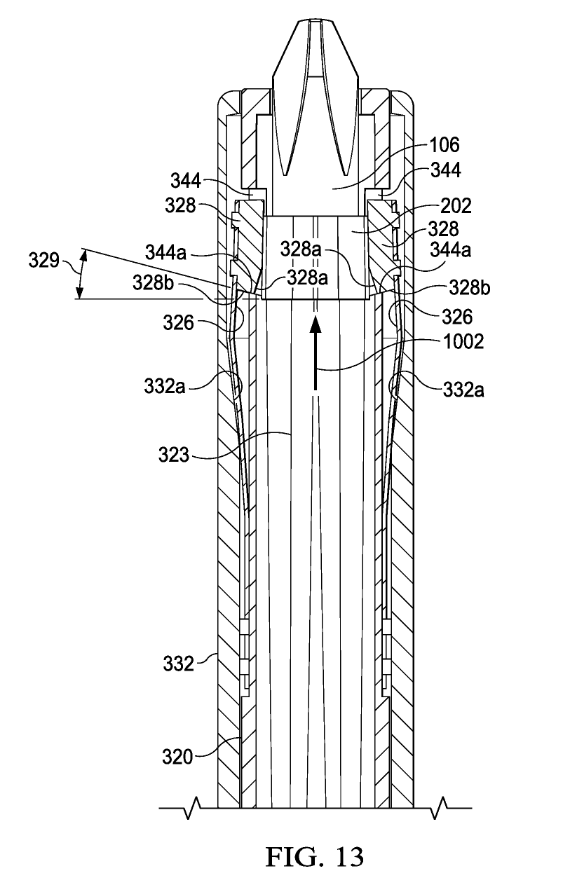

As more clearly depicted in FIG. 14A, toward the upper end of barrel 320 and sleeve 332, the inside diameter of sleeve 332 opens along a taper 332a creating space 342. A leaf spring 326 is positioned between barrel 320 and sleeve 332 and secured thereto at 327 using securing means, such as conventional staking or clipping. A locking block 328 is positioned and secured atop each leaf spring 326. When sleeve 332 is in an upward position (as shown in FIGS. 9A, 10A, 11A, 12A, 13, and 14A), the taper 332a presses against leaf springs 326 causing the leaf springs to bias locking blocks 328 toward two corresponding openings 344 defined in barrel 320. Locking blocks 328 are further preferably provided with bottom surfaces 328b which seat on corresponding lower surfaces 344a of openings 344, both of which bottom surfaces 328b and lower surfaces 344a are inclined downwardly into the interior of barrel 320 at an angle 329 (FIG. 13) greater than zero but less than about 30° to further bias locking blocks 328 into openings 344. To prevent locking blocks 328 from falling into and through openings 344, sides 328c (FIG. 14B) of the locking blocks are configured in a wedge shape which wedges against sides 344c of openings 344. The wedging action is particularly acute when a load is applied to bit 106 (FIG. 14A) which then urges wedge-shaped sides 328c of locking blocks 328 inwardly against wedge-shaped sides 344c of openings 344, thus providing a backstop for supporting bit 106 under load. Locking blocks 328 preferably also define tapers 328a at lower ends of the barrel side of the blocks, for pushing locking blocks 328 outwardly against leaf spring 326 pressure, upon contact with bit 106, and allowing bit 106 to pass when it is moving upwardly through barrel 320, as shown in FIG. 13. Leaf spring 326 pressure is such that momentum of traveling bit 106 is capable of overcoming pressure and thereby pushes locking blocks 328 out of the bit path. Once bit 106 passes the locking blocks, the locking blocks return to the position of blocking the bit from moving back into barrel 320. Bit 106 continues travel toward an opening 346 at the end of barrel 320, and is restrained from traveling of the barrel by stop 348. It may be appreciated that as a user uses a finger to pull the sleeve 332 back, as depicted in FIG. 15, taper 332a moves downwardly allowing leaf springs 326 to expand outwardly into space 342, and locking blocks 328 to move outwardly from the openings 344 of the barrel 320. It may also be appreciated that surfaces of locking blocks 328 may be suitably curvilinear (i.e., non-flat) to conform with openings 344 and fit within the curved space 342. It may be further appreciated that the combination of locking blocks 328, leaf spring 326, sleeve 332, and stops 348 form a locking mechanism to secure a bit 106 in place at the end of the shaft 104.

In operation, with bits 106 loaded in cartridge cavities 402, a user selects bit 106 as shown most clearly by FIGS. 8A-8D, showing a cross-section of handle 102 taken along line 8-8 of FIG. 3D. FIG. 8A depicts an initial state of cartridges 308 in handle 102. By way of example, if a user desires to use bit 106 in cartridge 308a, then he would apply force with a finger to button 404 of cartridge 308a in a direction indicated by arrow 820. As cartridge 308a is pushed inwardly, cartridges 308b are pushed outwardly, until cartridge 308a is positioned as shown in FIG. 8C, at which point cartridges 308b are restored to their original position, which tends to hold cartridge 308a in its new position shown in FIG. 8C. The negative polarity of magnet 408 of cartridge 308a and the negative polarity of magnet 316 (FIG. 3C), together with the positive polarity of magnet 406a of cartridge 308a and magnet 316 (FIG. 3B) further tend to repel and thereby restrain cartridge 308a in the position of FIG. 8C.

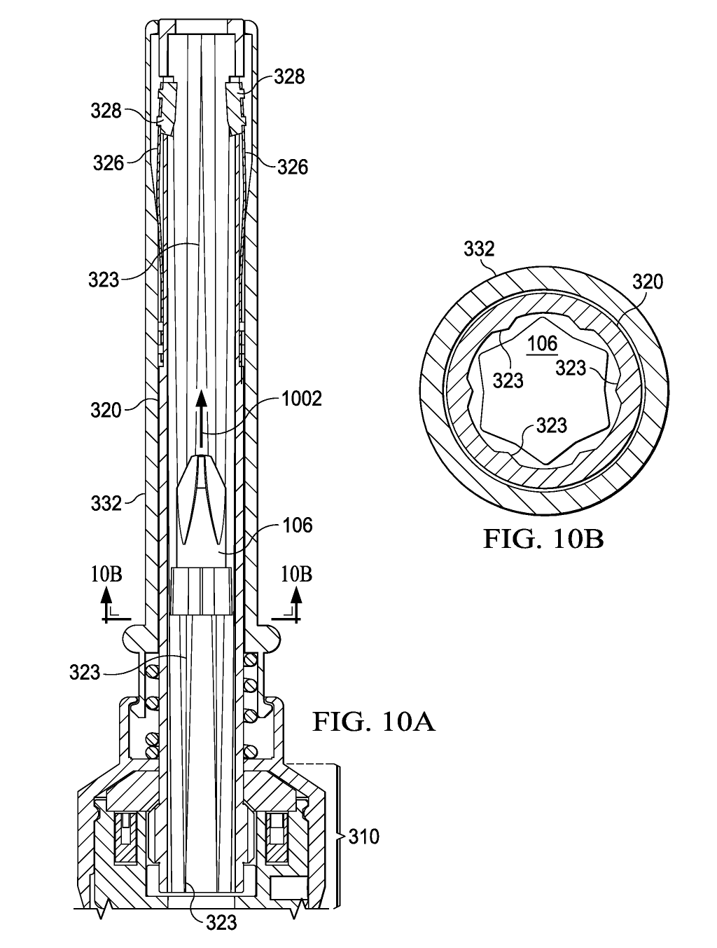

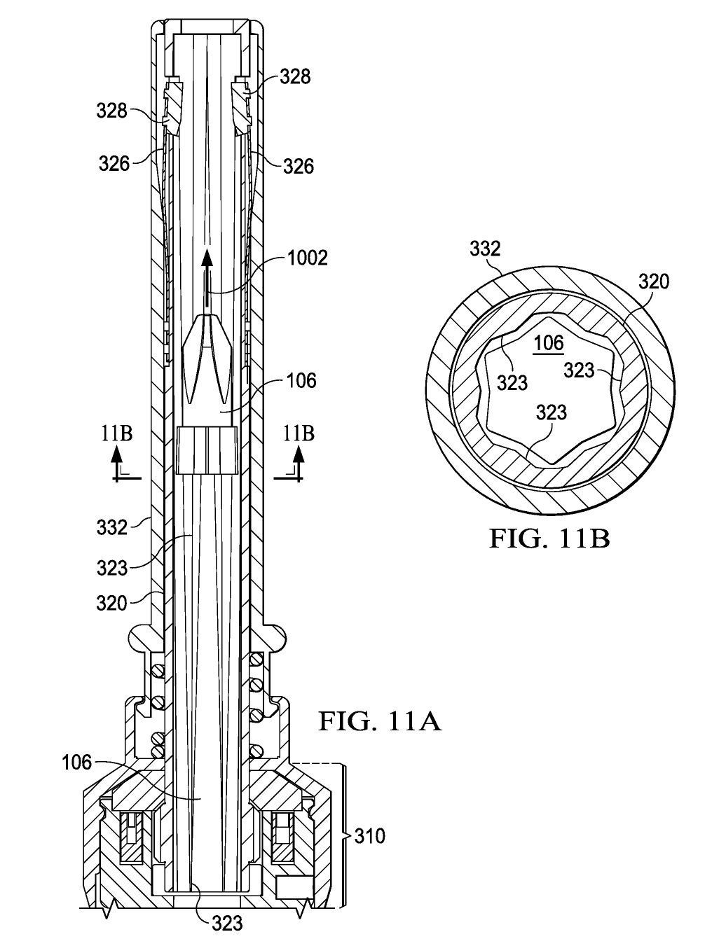

Once cartridge 308a is in the position of FIG. 8C, the bit 106 positioned in cavity 402 of cartridge 308a is aligned with the center of barrel 320. A user may then flick screwdriver 100 with his or her hand to apply centrifugal force to move bit 106 into and along barrel 320 as shown in FIG. 9A. FIG. 9B shows how the barrel 320 cross-section is substantially circular, with small lands 323. FIG. 9C shows the normal position of locking blocks 328 when bit 106 is not in position for use. FIG. 10A shows bit 106 moving upwardly in the direction of arrow 1002, and FIG. 10B shows how lands 323 are enlarging. FIG. 11A shows bit 106 continuing to move upwardly in the direction of arrow 1002, and FIG. 11B shows how lands 323 continue to enlarge toward sides 206 of base 202 of bit 106. FIG. 12A shows bit 106 continuing to move upwardly in the direction of arrow 1002 toward locking blocks 328, and FIG. 12B shows how lands 323 continue to enlarge toward sides 206 of base 202 of bit 106, almost coinciding with them. FIG. 13 shows bit 106 continuing to move upwardly and engaging locking blocks 328, causing locking blocks 328 to move outwardly, against spring 326 pressure, as bit 106 passes them. FIG. 14A shows bit 106 in position just above locking blocks 328 sufficiently to allow locking blocks 328 to re-enter openings 344 and prevent bit 106 from moving downwardly, while stops 348 prevent bit 106 from moving upwardly, thereby securing bit 106 in position for use. FIG. 14B shows how lands 323 fully engage sides 206 of base 202 of bit 106, thereby preventing bit 106 from rotating, rendering bit 106 ready for use. It can be appreciated that the configuration of lands 323 allows a bit 106 to enter barrel 320 at virtually any angular orientation, and to be adjusted in its orientation as it moves along inside the barrel so that at the upper end of the barrel, the bit is properly oriented with shaft 104, secured therein, and ready for use in screwdriver 100.

With reference to FIG. 15, when bit 106 is no longer needed or another bit is desired, bit 106 may be restored to its cartridge 308 by using a finger or thumb to pull downwardly on finger pulls 324, thereby pulling taper 332a back, and allowing leaf springs 326 to expand outwardly into space 342, thereby allowing bit 106 to fall back into the barrel, as indicated by arrow 1502, until it lands in cavity 402 of its respective cartridge 308, positioned as shown in FIG. 8C. With reference to FIG. 8D, a user may then press button 404 of cartridge 308d in the direction of arrow 822 to push cartridge 308a in the direction of arrow 824 back to its original position of FIG. 8A, but without pushing cartridge 308d to a position as shown by cartridge 308a in FIG. 8C. When cartridge 308d pushes cartridge 308a far enough for magnets 406 and 408 (FIGS. 4-7) of cartridge 308a to pass over magnets 316 (FIGS. 3B, 3C), the magnetic force repels the cartridge back to its original position as shown in FIG. 8A. At this point, the user stops pushing in the direction of arrow 822 and magnetic forces of magnets 316 (FIGS. 3B, 3C) attracting cartridge 308d magnets 406, 408 and 410, attract cartridge 308d back to its original position, shown in FIG. 8A.

If bits 106 have not been or are not loaded into cartridge cavities 402, then, with reference to FIGS. 8B and 8C, a user may continue pushing cartridge 308a until cartridge 308a engages and pushes cartridge 308d far enough out of its respective cell 306 so that a user may grab and pull cartridge 308a out of respective cell 306. A bit 106 may then be loaded into cavity 402 of cartridge 308d. Cartridge 308d is then placed back into its respective receiver cell 306 and pushed in until it engages cartridge 308a as shown in FIG. 8D and pushes cartridge 308a until its respective magnets 314 and 316 pull cartridge 308a back to a proper position in its respective cell 306. Cartridge 308d is then released so that its respective magnets 314 and 316 may pull cartridge 308d back to its proper position within its respective cell 306. The same procedure used to load bits 106 may also be used to unload or remove bits 106 from a cartridge cavity 402, or to replace bits 106 with other bits 106.

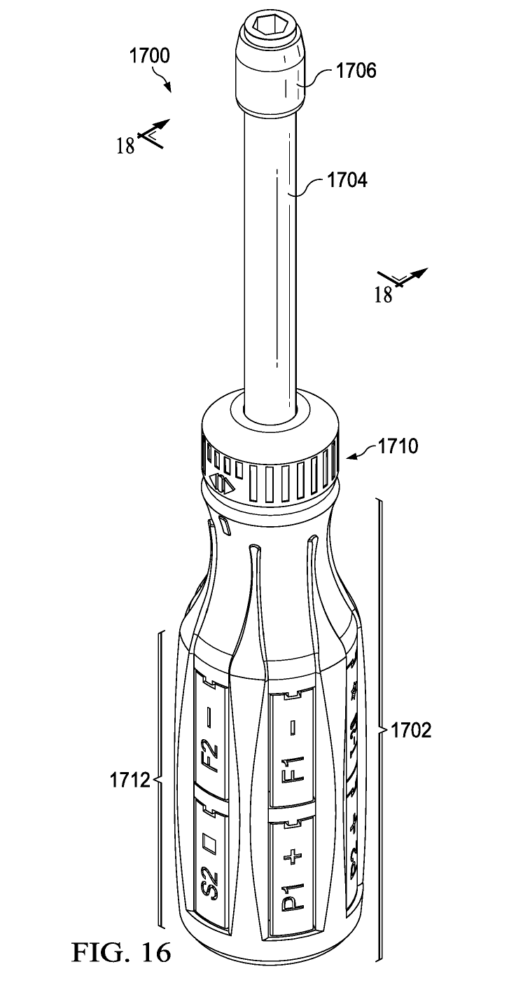

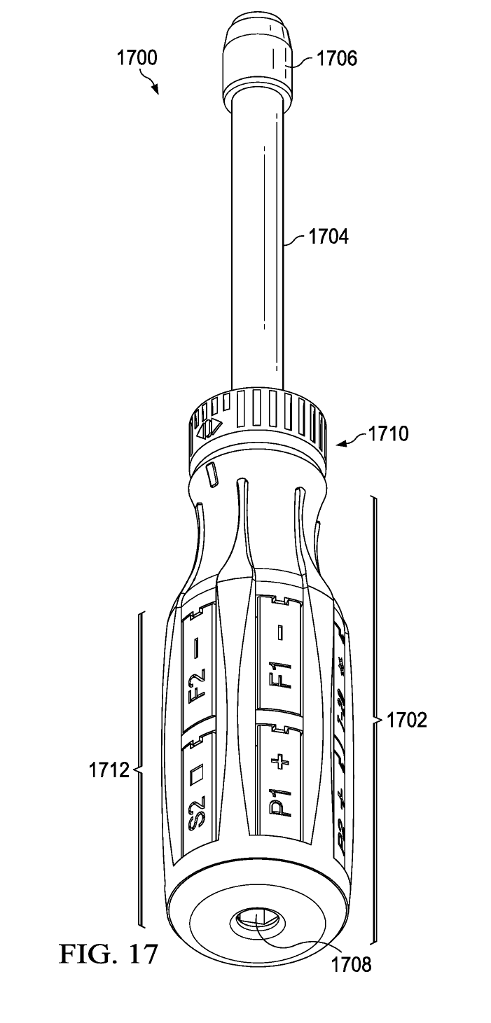

FIG. 16 depicts a screwdriver 1700 according to an alternate embodiment of the invention, similar to the embodiment of screwdriver 100 described above with respect to FIGS. 1A-15, but in which a selected bit 106 is dropped out of an opening defined in a lower end of the handle, rather than being passed through the shaft 1704. Accordingly, as shown in FIG. 16, screwdriver 1700 preferably includes a handle 1702, a ratchet 1710, a shaft 1704, and a driver 1706. The handle 1702 includes a bit holder portion 1712. As shown in FIG. 17, a lower end of handle 1702 defines an opening 1708 through which bits 106 may fall out, as discussed below.

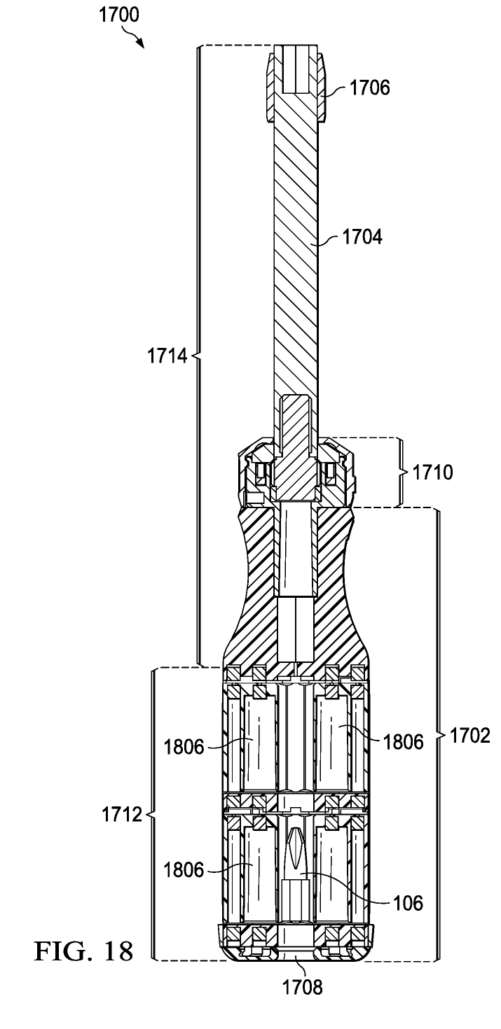

FIG. 18 depicts a cross-section of screwdriver 1700 taken along the line 18-18 of FIG. 16. Bit holder portion 1712 of handle 1702 as shown is configured with six columns and two rows defining twelve cells 1806 for holding up to twelve cartridges and bits 106 in a manner similar to screwdriver 100 described above. As with the embodiment described above with respect to FIGS. 1A-15, the number of columns may vary from six columns, and the number of rows may vary from two or three. While not shown, cells 1806 are adapted for receiving the same cartridges 308 as described above with respect to screwdriver 100 of FIGS. 1A-15. Cells 1806 are virtually identical to cells 306 but for being oriented 180° (about a horizontal axis) from cells 306 relative to the rest of the screwdriver, and therefore will not be described in further detail herein.

A portion 1714 of screwdriver 1700 above bit holder 1712 is configurable in any suitable manner as a conventional screwdriver, and therefore will not be discussed in further detail herein.

Operation of screwdriver 1700 of FIGS. 16-18 is similar to operation of screwdriver 100 of FIGS. 1A-15, except when a user presses button 404 of cartridge 308, a bit falls downwardly, as viewed in FIG. 18, and out through opening 1708, for capture by a user. The user then mounts bit 106 onto driver 1706. When work using the bit 106 is complete, the bit is manually removed from driver 1706, the screwdriver is oriented with opening 1708 facing upwardly, and the bit is placed in opening 1708, wherein it falls into cartridge 308 from whence it came, and the cartridge is pushed back into position shown in FIG. 8A and discussed above.

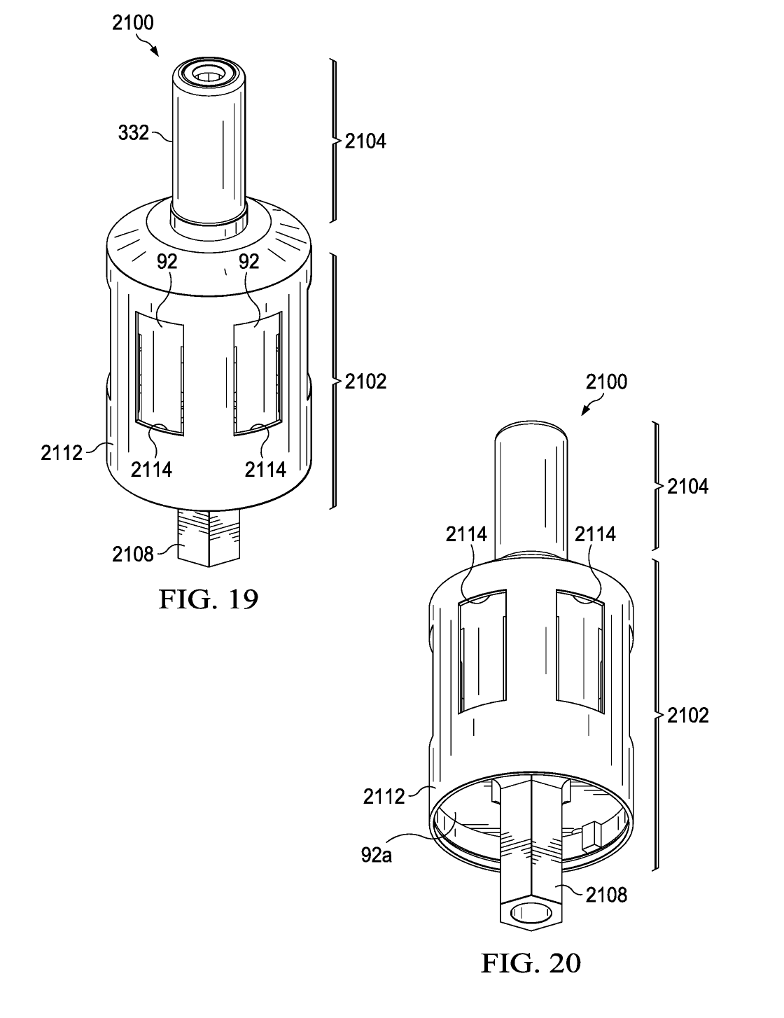

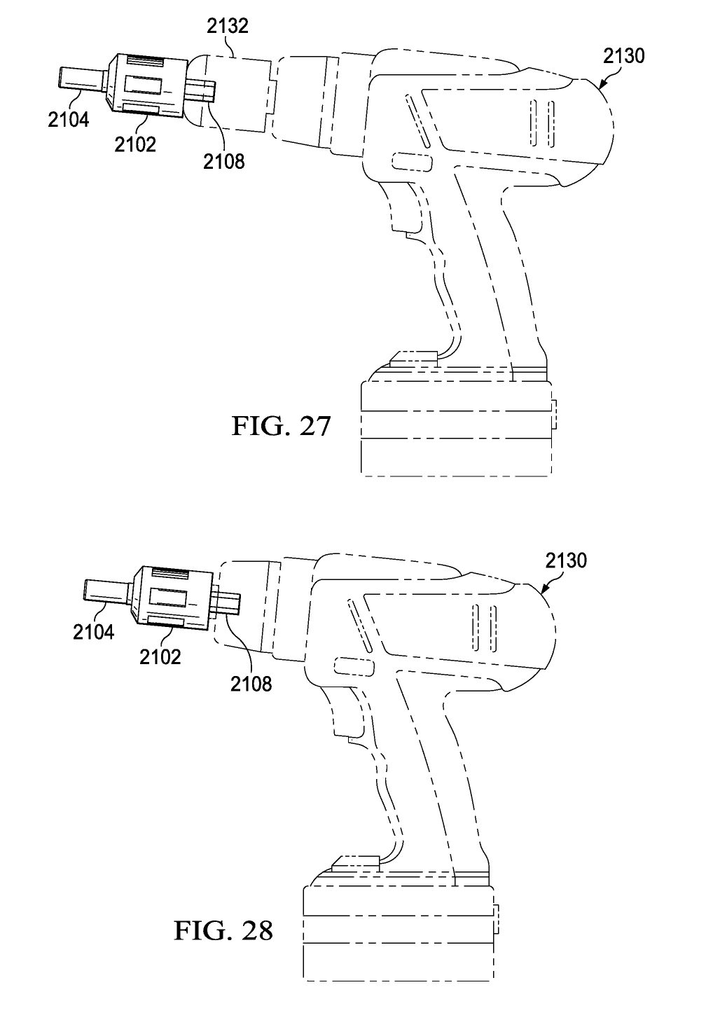

FIGS. 19-28 depict a power screwdriver 2100 according to an alternate embodiment of the invention wherein multi-bit screwdriver 100 is adapted for being driven by a power tool, such as a power drill (FIGS. 27-28), by adding a shank to a bottom end of the screwdriver, and an outer cover 2112 configured to prevent cartridges 308 from flying out of respective cells from centrifugal force generated when a power drill spins the screwdriver at high speeds. Since power screwdriver 2100 contains many components that are similar or identical to those of screwdriver 100, exemplified by FIGS. 2-15, such components are referred to by the same reference numerals and will not be described in any further detail.

FIGS. 19 and 20 show two perspective views of one embodiment of power screwdriver 2100, including a shank 2108 extending from a bottom side 92a of receiver 92, and wherein receiver 92 comprises only a single row 304 (FIG. 3D) of cells 306 (FIG. 3A) and a shaft 2104 is similar to shaft 104, but is relatively shorter. It is understood that power screwdriver 2100 may be configured with multiple rows 304 of cells 306 and that shaft 2104 may be scaled longer or shorter. In a preferred embodiment, an outer cover 2112 envelopes cells 306 of receiver 92, and defines openings 2114 configured for providing access to cells 306 of the receiver. Outer cover 2112 is preferably coupled to or integral with sleeve 332 to move synchronously with the sleeve.

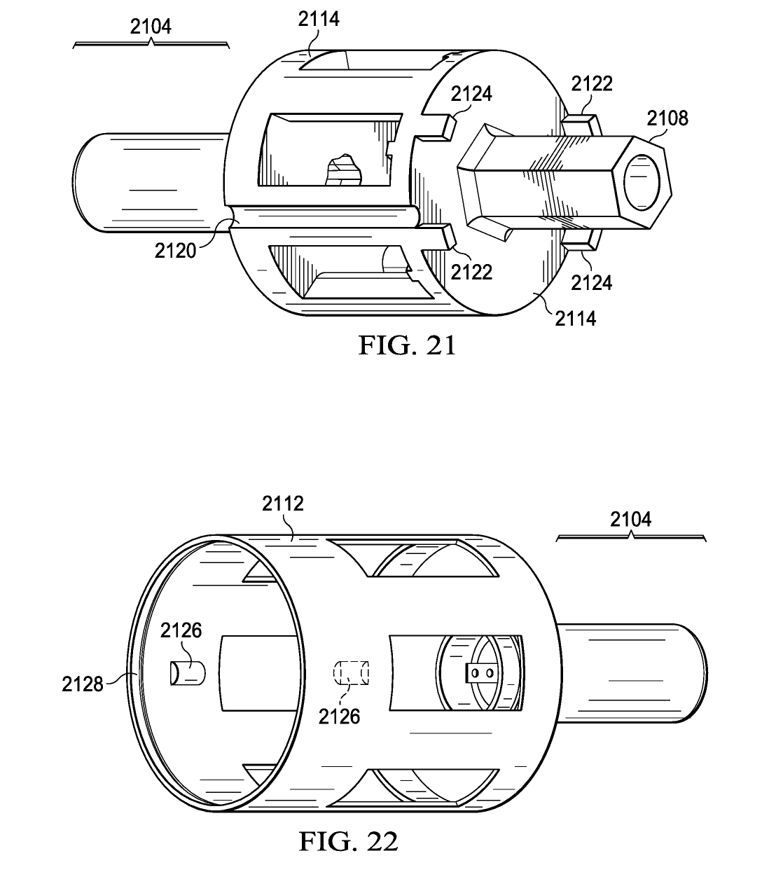

FIG. 21 shows power screwdriver 2100 receiver 92 without outer cover 2112. As depicted, a longitudinal groove 2120 is defined in the receiver. In a preferred embodiment, a second longitudinal groove (not shown) is defined on an opposing side of the receiver.

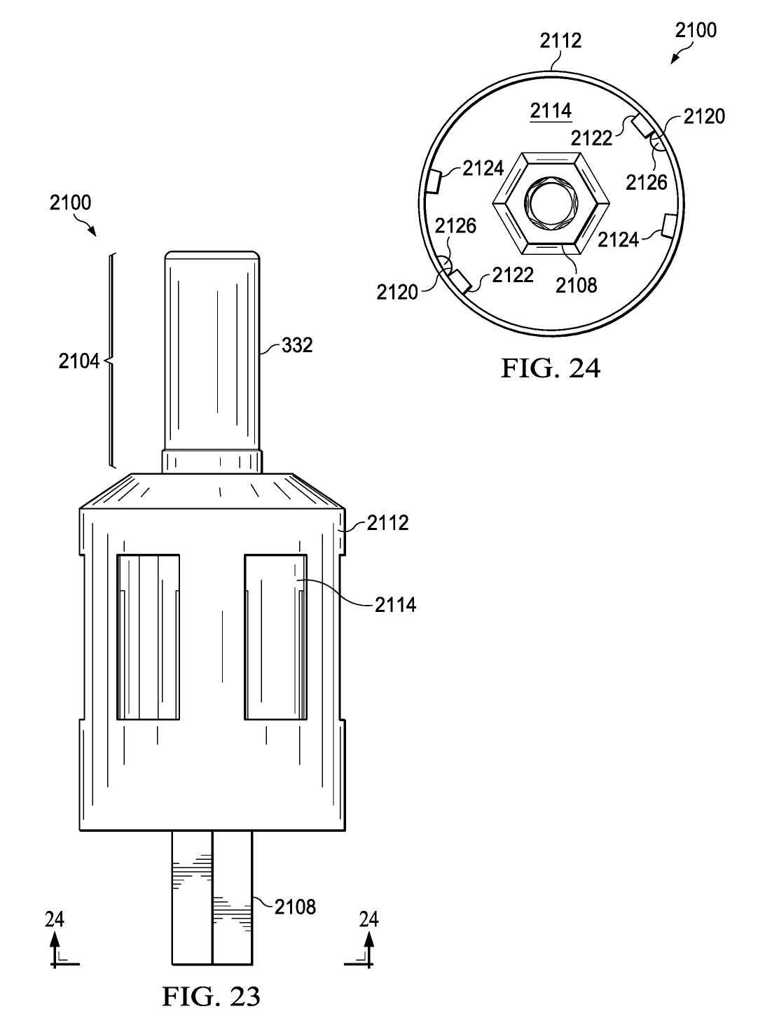

FIG. 22 shows the power screwdriver 2100 outer cover 2112 without receiver 92. As depicted, two tongues 2126 extend inwardly from an inward surface of the outer cover. Tongues 2126 are configured to matingly engage and slide along complementary grooves 2120 when outer cover 2112 is positioned about receiver 92. It is noted that outer cover 2112 is coupled to sleeve 332 for synchronous movement with the sleeve. Thus, coil spring 330 (see, e.g., FIG. 9A) that biases sleeve 332 in a forward (upward, as viewed in FIG. 23) position toward the end of shaft 2104, also biases outer cover 2112 in a forward position. A retaining ring (not shown) or the like is preferably positioned in a groove 2128 in an end of outer cover 2112 to limit the bias of spring 330 and the forward movement of outer cover 2112.

FIGS. 23 and 24 illustrate an operating mode of power screwdriver 2100.

As shown most clearly in FIG. 24, two tongues 2126 engage complementary grooves 2120 permitting spring 330 to slide outer cover 2112 and sleeve 332 into a forward position. In such position, outer cover 2112 covers cells 306, precluding external access to cartridges 308, and also preventing cartridges 308 from flying out of respective cells from centrifugal force generated when a power drill spins screwdriver 2100 at high speeds. It is noted that open stops 2122 and closed stops 2124 limit how much outer cover 2112 can be rotated when opening or closing, respectively, outer cover 2112.

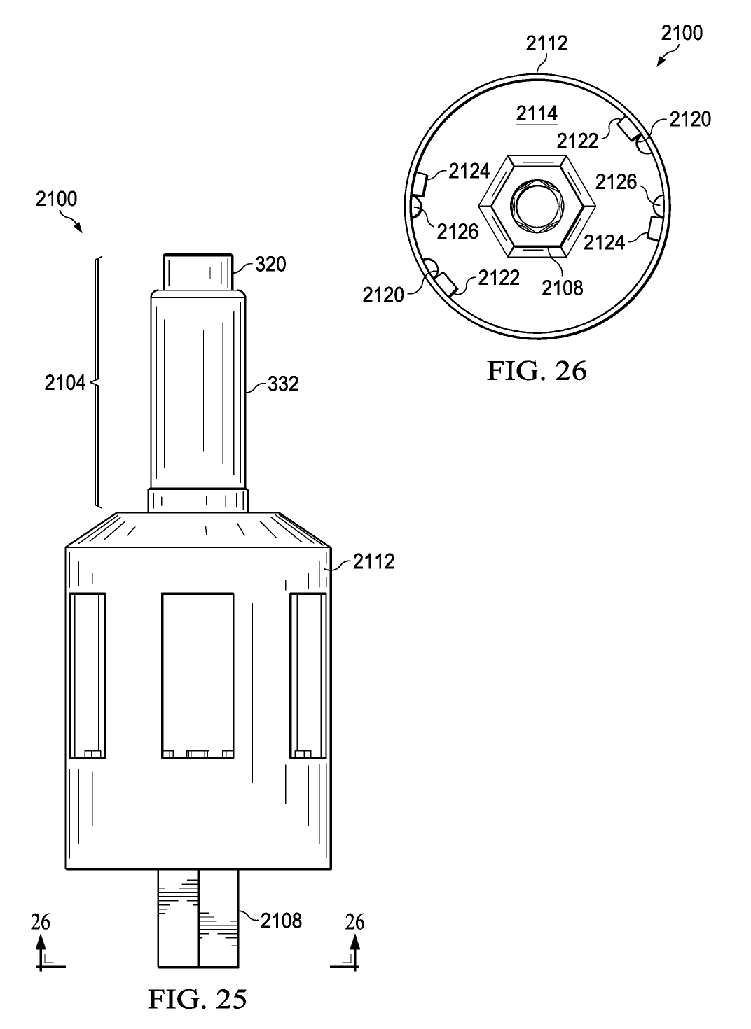

FIGS. 25 and 26 illustrate a bit changing mode of power screwdriver 2100. As shown most clearly in FIG. 26, two tongues 2126 do not engage complementary grooves 2120, and so restrain outer cover 2112 and sleeve 332 in a rearward position. In such position, outer cover 2112 allows access to cells 306, thereby permitting external access to cartridges 308 so bits 106 may be selected, removed, or changed, as discussed above with respect to FIGS. 2-15.

FIGS. 27 and 28 exemplify how screwdriver 2100 may be coupled to a power drill 2130. In FIG. 27, shank 2108 is secured in a chuck 2132 to thereby form a temporary coupling. In FIG. 28, a more permanent coupling between screwdriver 2100 and power drill 2130 is formed when shank 2108 is secured directly to power drill 2130.

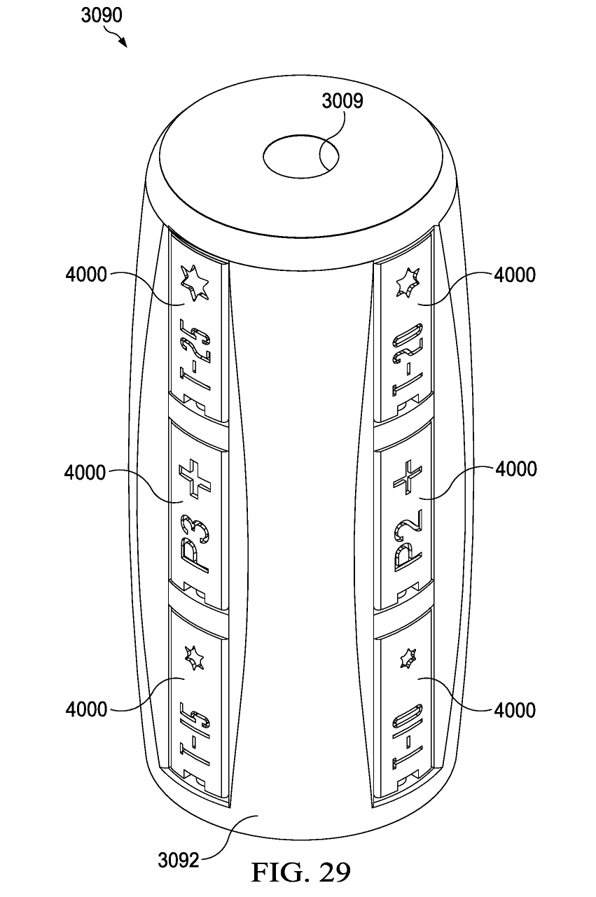

FIGS. 29-40 depict details of a storage device 3090, also exemplified as a multi-bit screwdriver 3000, according to a further alternate embodiment of the present invention, wherein the function previously achieved using magnets is now achieved using springs. Since storage devices 3000 and 3090 contain many components that are identical to those of previous embodiments, these components are referred to by the same reference numerals and will not be described in any further detail.

More specifically, according to the embodiment of FIG. 29, the reference numeral 3090 generally designates an alternative embodiment of a storage device, similar to the embodiment of FIG. 1, embodying features of the present invention for storing bits, as defined above. Storage device 3090 includes a receiver 3092 that defines at least one cell (not shown in FIG. 29) for receiving at least one cartridge 4000 defining a cavity for storing a storage item. Storage device 3090 further includes a passageway extending longitudinally along the center of the receiver to an opening 3009 defined in an external surface of the receiver for inserting items into the unit, and for retrieving items from the unit. Passageway 3009 facilitates passage of a selected bit between a cartridge 4000 cavity and the opening 3009. In the interest of efficiency, the storage functionality of device 3090 is described in further detail below with respect to one application relating to a multi-bit screwdriver.

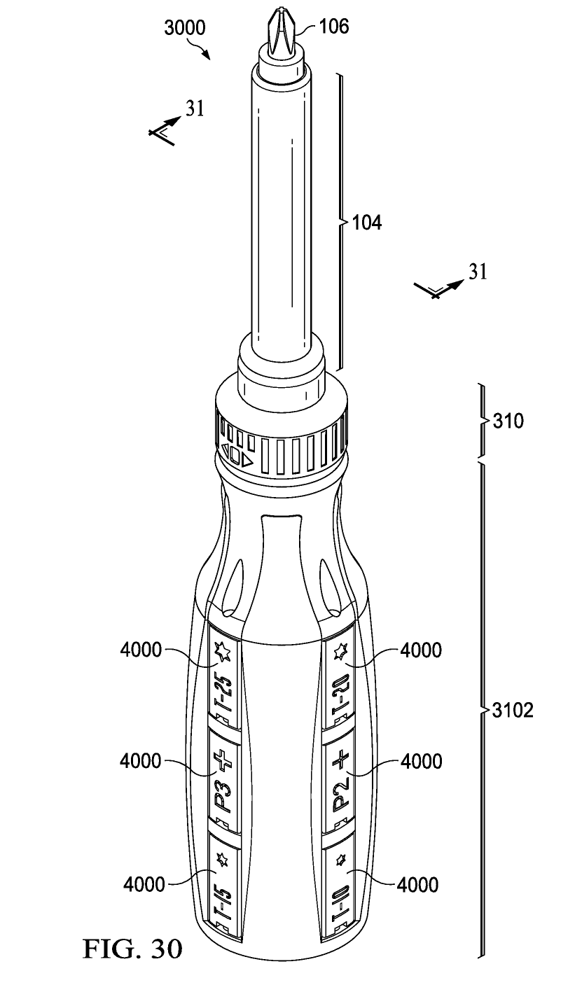

Accordingly, in FIG. 30 of the drawings, the reference numeral 3000 generally designates a multi-bit screwdriver embodying features of the present invention. Screwdriver 3000 preferably includes a handle portion 3102, a ratchet 310, a shaft portion 104, and a bit portion 106. Ratchet 310, shaft portion 104, and bit portion 106 have been described in some detail above, and so will not be described in further detail herein, but handle portion 3102 will be described in further detail below.

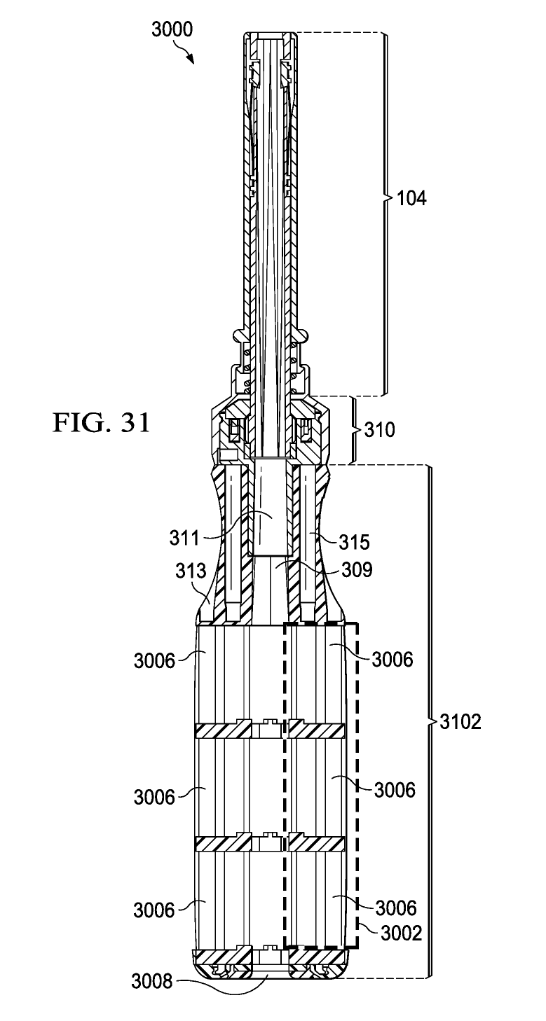

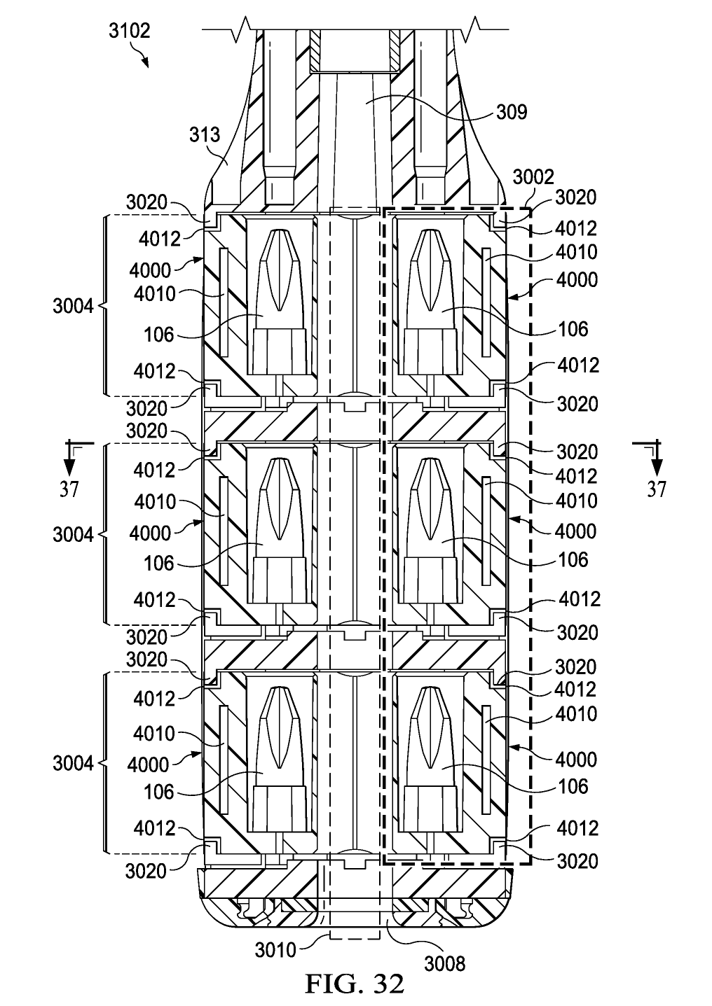

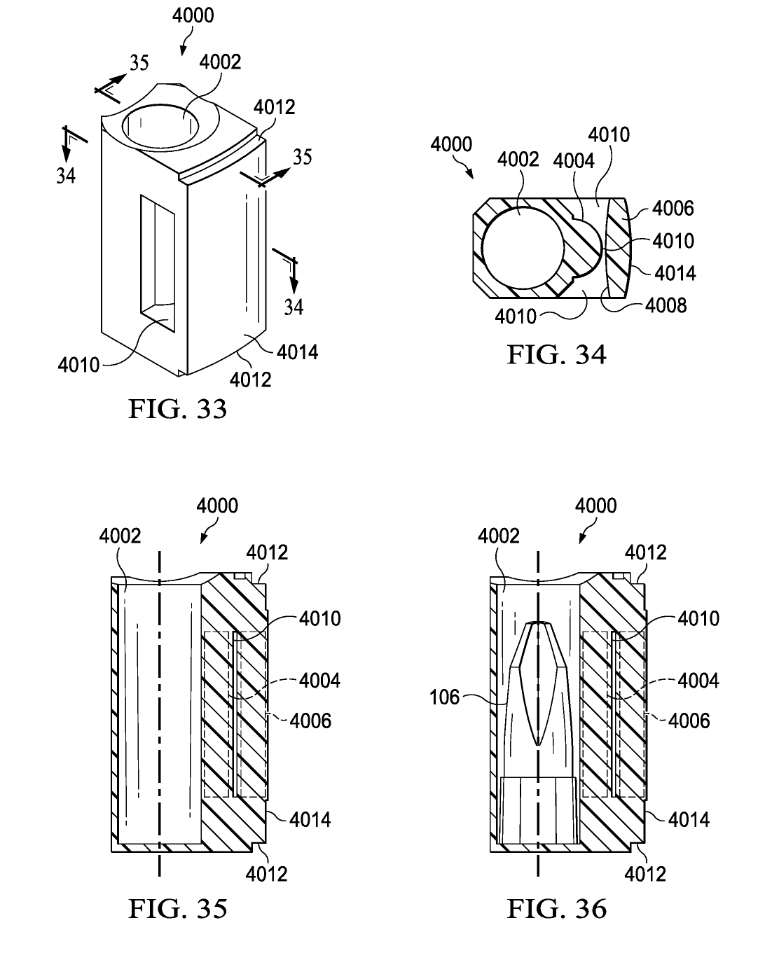

The alternate embodiment of the invention as depicted by FIGS. 31 and 32 correspond to and are similar to the embodiment of the invention depicted by FIGS. 3A and 3D, but for cartridge 308 and magnets 314, 316, 406, 408, and 410 being replaced by cartridge 4000 configured for cooperating with a spring mechanism described below with respect to FIGS. 33-38D.

As depicted by FIGS. 33-36, a cartridge 4000 defines a cavity 4002, a passageway 4010, grooves 4012, and button 4014. As shown by FIGS. 34-36, passageway 4010 extends through the cartridge and between cartridge portions 4004 and 4006. As shown most clearly by FIG. 36, cavity 4002 is effective for receiving and storing bit 106. Grooves 4012 are configured to matingly engage flanges 3020 (FIG. 32), which flanges are configured to prevent cartridges 4000 from falling out of handle 3102.

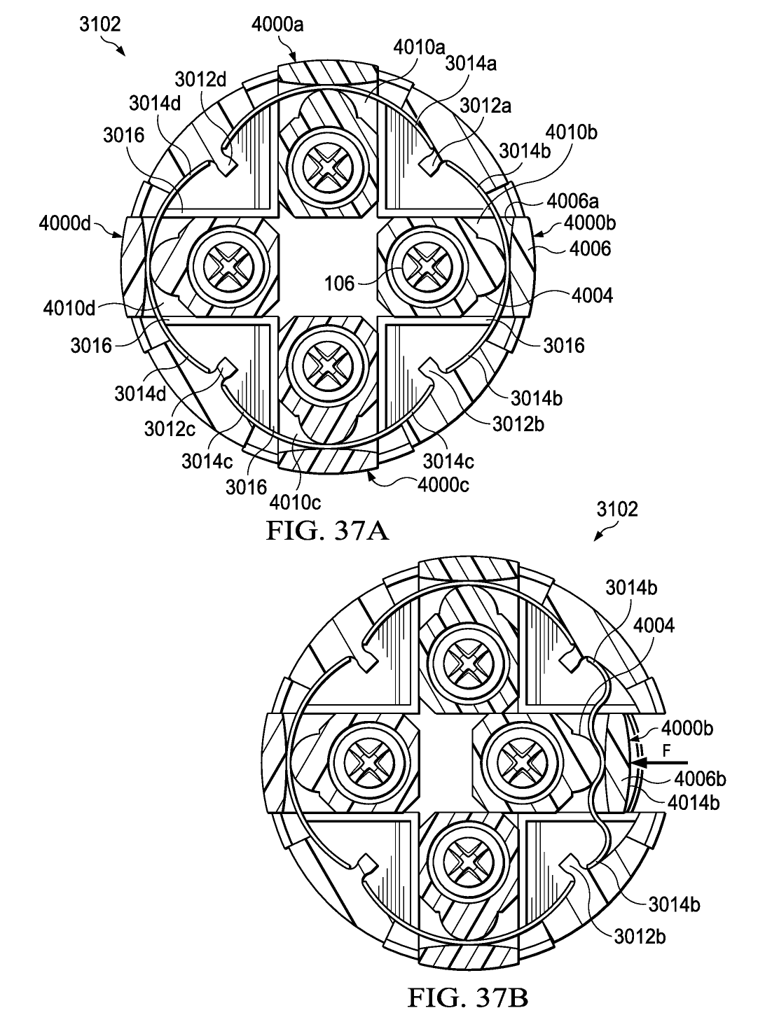

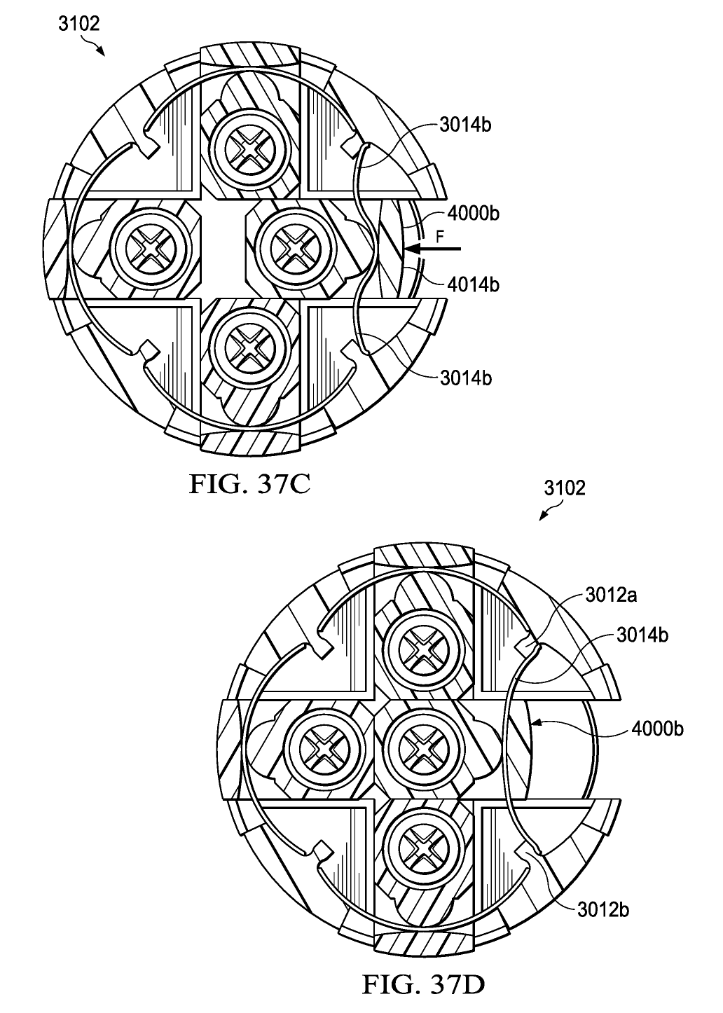

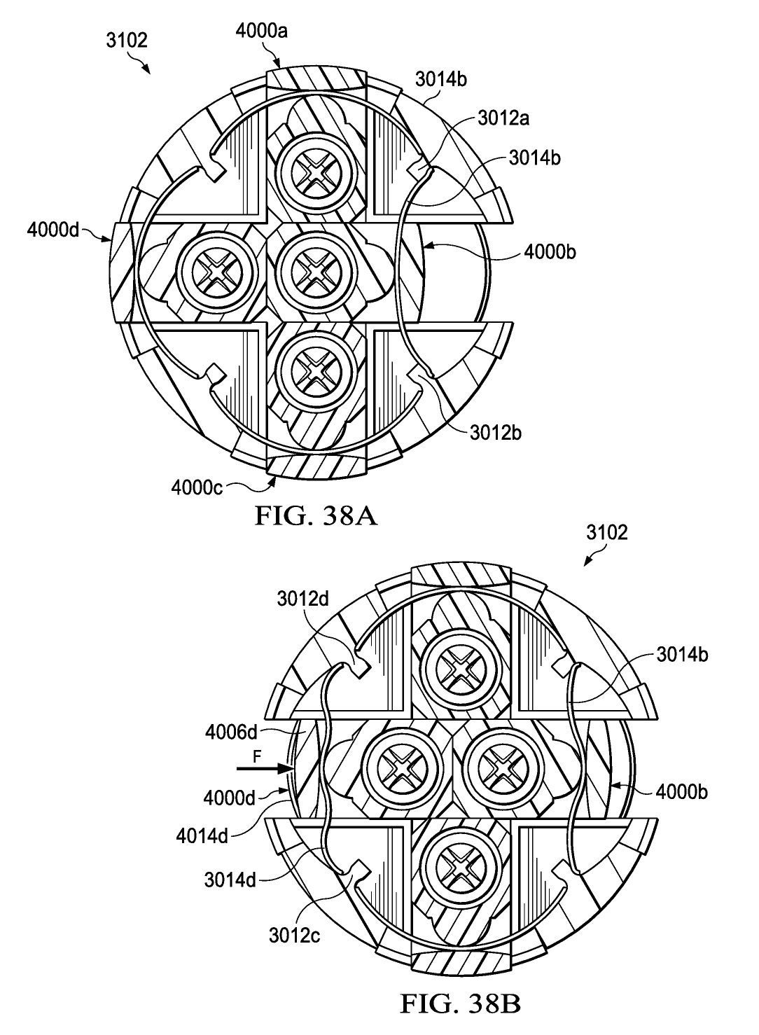

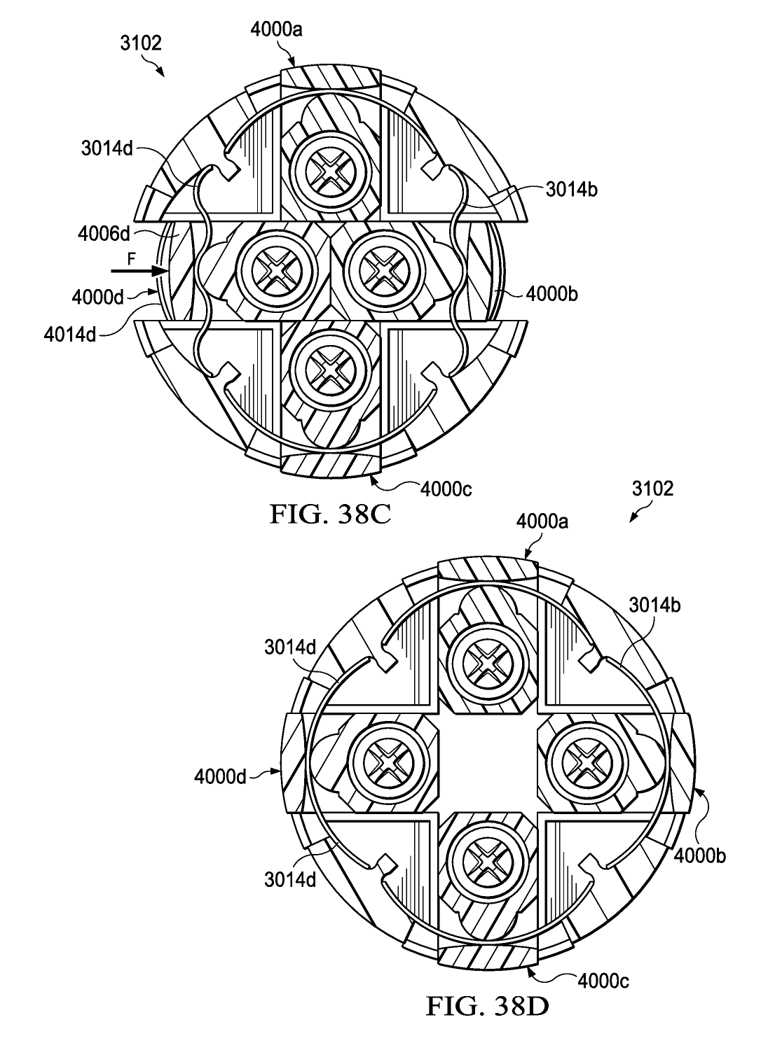

FIGS. 37A-37D are taken along line 37-37 of FIG. 32, and exemplify a sequence of states of the cartridges of FIGS. 33-36 for positioning a selected bit for use, from four bits depicted in each of FIGS. 37A-38D. As shown in FIG. 37A, four cartridges 4000a, 4000b, 4000c, and 4000d (also referred to collectively as cartridges 4000) are slidably positioned within respective cartridge guides 3016. Stops 3012a, 3012b, 3012c, and 3012d (referred to collectively as stops 3012) extend inwardly within handle portion 3002 between the cartridges and cartridge guides. Springs 3014a, 3014b, 3014c, and 3014d (referred to collectively as springs 3014) are positioned between respective stops. Each spring preferably comprises a thin strip of sheet material, such as plastic (e.g., BoPET (biaxially-oriented polyethylene terephthalate), also known as Mylar®) or metal, that is flexible without yielding. Springs 3014 are sized to pass through passageway 4010 in an arcuate shape and be restrained at respective stops 3012.

In operation, with reference to FIG. 37A, if it is desired to use a bit 106 in cartridge 4000b, then a user applies a force F to respective button 4014 of cartridge 4000b as indicated by the arrow designated with the letter F in FIG. 37B. As force is applied, cartridge 4000b moves leftwardly within guides 3016 of handle portion 3002, and spring 3014b assumes a convoluted unstable shape which initially resists the leftward movement. With continued application of force F, spring 3014b assumes a convoluted unstable shape which facilitates leftward movement of cartridge 4000b, as shown in FIG. 37C. Cartridge 4000b then moves, with or without the continued application of force F, toward a stable position, as depicted in FIG. 37D, wherein bit 106 is aligned with the center of barrel 320. Bit 106 may then be moved into and along barrel 320 for use as shown and described above with respect to FIGS. 9A-14B.

Once bit 106 is in position for use, cartridge 4000b may be restored to its original position shown in FIG. 37A. This is done by applying force F to button 4014d of opposing cartridge 4000d, causing cartridges 4000d and 4000b to move rightwardly, as shown in FIG. 38B. Initially, springs 3014b and 3014d assume convoluted unstable shapes which resist the movement of cartridges 4000b and 4000d. With continued application of force F, cartridges 4000b and 4000d continue to move rightwardly, and spring 3014b assumes a convoluted unstable shape which facilitates further rightward movement of cartridge 4000b, while spring 3014d continues to resist rightward movement of cartridge 4000d. Force F is then removed and springs 3014b and 3014d return cartridges 4000b and 4000d to their original positions as depicted in FIG. 37A.

When bit 106 is no longer needed or another bit is desired, bit 106 may be restored to its cartridge 4000b. To do that, cartridge 4000b is first re-positioned as shown in FIG. 37D following steps described above with respect to FIGS. 37A-37D. Bit 106 is then released from barrel 320 and allowed to fall back down into cavity 4002b of cartridge 4000b, as described above with respect to FIG. 15 and cavity 402 of a respective cartridge 308. Cartridge 4000b is then moved back to its original position (FIG. 38D) as described above with respect to 38A-38B.

To replace a bit 106 in a cavity 4002 of a cartridge, e.g., cartridge 4000b of screwdriver 3000, the bit to be removed or replaced is deployed to the “drive” position at the end of shaft 104 (FIG. 30) as discussed above with respect to FIGS. 37A-37D and 9A-14B. Cartridge 4000b is then positioned in a “storage” (outer perimeter) position (FIG. 38D), so that center channel 3010 is open. Screwdriver 3000 is then vertically oriented so that shaft 104 and bit 106 point upwardly. Bit 106 is then released by retracting the locking mechanism as described above with respect to FIG. 15, and the bit travels downwardly, through center channel 3010, and out through opening 3008 in the bottom cap of handle 3102. If the removed bit is to be replaced, then screwdriver 3000 is turned 180° so that it is pointing downward. The replacement bit is inserted through opening 3008 in the bottom cap of handle 3102, and it falls, via gravity, to the tip of shaft 104 (FIG. 30). Cartridge 4000b (or any other cartridge with an empty cavity 4002) is “pushed” so cavity 4002 is aligned with the center channel 3010. Bit 106 is then released and it falls into cartridge cavity 4002. Cartridge 4000b is then returned to its outer perimeter (FIG. 38D) as described above with respect to FIGS. 38A-38D.

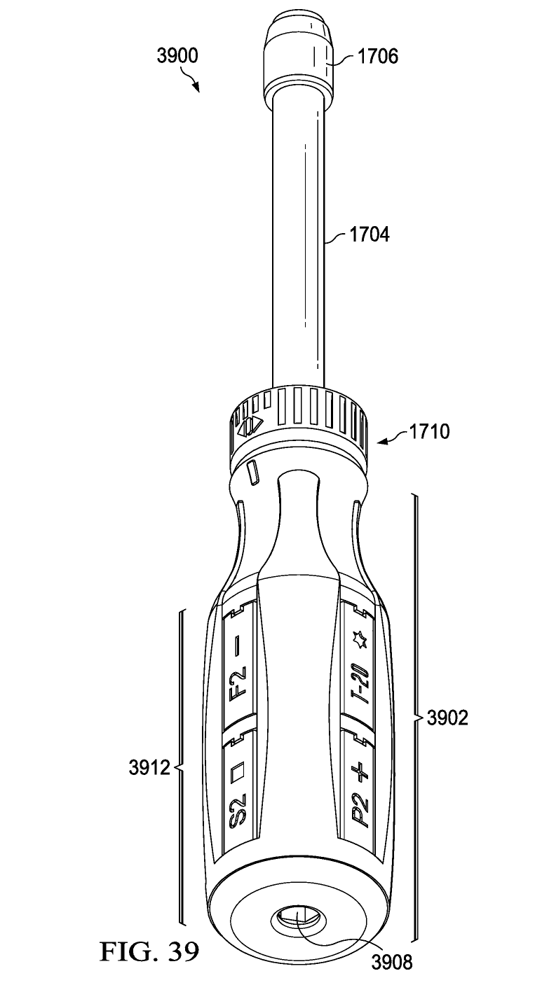

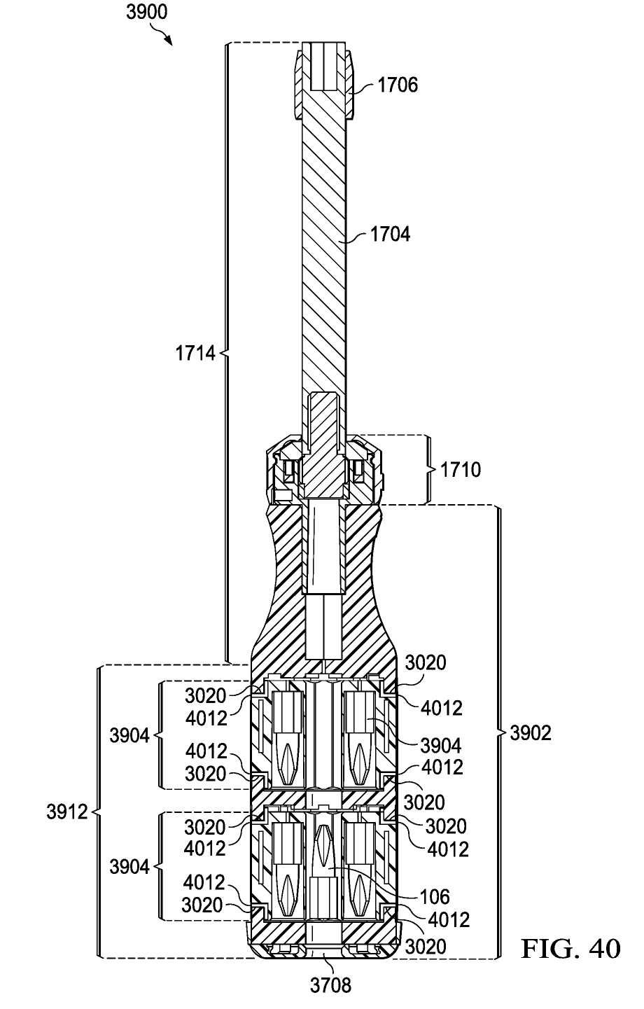

FIGS. 39 and 40 depict a further alternate embodiment of the invention, exemplified as a screwdriver 3900, similar in function to the embodiment of FIGS. 16-18, but, most significantly, for using springs 3014, as discussed above with respect to FIGS. 29-38D, to achieve what magnets had previously been used to achieve. Accordingly, screwdriver 3900 includes a ratchet 1710, a shaft 1704, and a driver 1706 which are substantially similar to the elements of the same respective number in FIGS. 16-18. More significantly, screwdriver 3900 includes a novel handle 3902 having cartridges 3904 which are substantially similar to cartridges 4000, but for being oriented within the screwdriver 180° from cartridges 4000. While two rows of cartridges are depicted, any number of rows (e.g., one, three) of cartridges may be configured.

As with screwdriver 1700, the portion 1714 of the screwdriver 3900 above the cartridges 3904 is configurable in any suitable manner as a conventional screwdriver, and therefore will not be discussed in further detail herein.

From a user perspective, operation of screwdriver 3900 of FIGS. 39-40 is similar to operation of screwdriver 1700 of FIGS. 16-18. The only significant operational difference is internally, wherein springs 3014, rather than magnets, are used as described above with respect to FIGS. 37A-38D.

It is understood that the present invention may take many forms and embodiments. Accordingly, several variations may be made in the foregoing without departing from the spirit or the scope of the invention. For example, someone could use similar cartridge configuration but bias them with elastic or other spring material. In another example, the function performed by the tongues 2126 and grooves 2120 for the outer cover 2112 and receiver 92 may be performed by other means, such as ball and detent. In yet another example, second grooves similar to grooves 2120 could be formed in receiver 92 for receiving tongues 2126 in the closed position of outer cover 2112. In a still further example, the function performed by magnets 314, 316, 406, 408, and 410 for biasing cartridges 308 as described above could be performed by springs

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered obvious and desirable by those skilled in the art based upon a review of the foregoing description of preferred embodiments. Accordingly, it is appropriate that the appended claims be construed broadly and in a manner consistent with the scope of the invention.

1. A storage device comprising:
one or more cartridges, each cartridge defining a respective cavity of one or more cavities for receiving a respective storage item of one or more storage items, the one or more cartridges further defining a slot;
a receiver defining two or more radially extending cells for receiving the one or more cartridges, and defining a passageway extending longitudinally along the center of the receiver to an opening defined in an external surface of the receiver;
two or more stops, each of the one or more stops being interposed on the receiver between two adjacent cells of the one or more radially extending cells; and
one or more springs, each of the one or more springs extending through a slot of a respective cartridge of the one or more cartridges and being positioned and restrained between two adjacent stops of the two or more stops, each spring of the one or more springs being sized to bow between the two stops and bias each of the one or more cartridges in a first position in the one or more cells wherein the cavity is not aligned with the passageway, or in a second position in the one or more cells wherein the cavity is aligned with the passageway.

2. The storage device of claim 1 wherein each spring is fabricated from a sheet of biaxially-oriented polyethylene terephthalate.

3. The storage device of claim 1 further comprising guides positioned on the receiver for guiding movement of each of the one or more cartridges.

4. The storage device of claim 1 wherein the one or more cartridges comprise a selected cartridge and at least three non-selected cartridges, wherein, when the selected cartridge is placed in the second position, the at least three non-selected cartridges bias the selected cartridge to remain in the second position.

5. The storage device of claim 1 wherein there are multiple rows of cells.

6. The storage device of claim 1 wherein the one or more storage items comprise one or more bits.

7. The storage device of claim 1 wherein the one or more storage items comprise at least one of an artist charcoal pencil, children's crayons, drill bits, thread cutting taps, bobbins for sewing, spices, gauge pins, screwdriver bits, and fishing weights.

8. The storage device of claim 1 wherein the one or more storage items comprise one or more bits, and wherein the storage device further comprises:
a tubular shaft extending from the opening in the storage device for receiving from a cartridge cavity a selected bit of the one or more bits;
a passageway defined within the tubular shaft for facilitating travel of the selected bit from the opening in the storage device to an end of the shaft opposing the opening; and
a locking mechanism for securing the selected bit at the end of the tubular shaft opposing the opening at an end of the tubular shaft.

9. The storage device of claim 1 wherein the one or more storage items comprise one or more bits, each of the one or more bits having a head portion and a base portion, the base portion defining a plurality of sides, and wherein the storage device further comprises:
a tubular shaft extending from the opening in the storage device for receiving from one of the one or more cavities a bit selected from the one or more bits, wherein the tubular shaft defines an interior portion having a plurality of lands corresponding in number to the plurality of sides of the base portion of the one or more bits; and
a locking mechanism for securing the selected bit at an end of the tubular shaft.

10. The storage device of claim 1 wherein the one or more storage items comprise one or more bits having a head portion and a base portion, the base portion defining a plurality of sides, and wherein the storage device further comprises:
a tubular shaft extending from the opening in the storage device for receiving from one of the one or more cavities a selected bit of the one or more bits, wherein the tubular shaft defines an interior portion having a plurality of lands corresponding in number to the plurality of sides of the base portion of the one or more bits, the interior portion having an entry end proximate to the opening in the storage device, and an exit end opposing the entry end, and wherein the lands are smaller at the entry end than at the exit end, and substantially conform to the shape of the base portion of the selected bit at the exit end; and
a locking mechanism for securing the selected bit at the exit end of the tubular shaft.

11. The storage device of claim 1 wherein the one or more storage items comprise one or more bits, of the one or more bits having a head portion and a base portion, the base portion defining a plurality of concave sides, and wherein the storage device further comprises:
a tubular shaft extending from the opening in the storage device for receiving from one of the one or more cavities a selected bit of the one or more bits, wherein the tubular shaft defines an interior portion having a plurality of lands corresponding in number to the plurality of sides of the base portion of the one or more bits, the interior portion having an entry end proximate to the opening in the storage device, and an exit end opposing the entry end, and wherein the lands are smaller at the entry end than at the exit end, and substantially conform to the shape of the base portion of the selected bit at the exit end; and
a locking mechanism for securing the selected bit at the exit end of the tubular shaft.

12. The storage device of claim 1 wherein the one or more storage items comprise one or more bits, of the one or more bits having a head portion and a base portion, the base portion defining a plurality of concave sides, the sides being conically canted toward the head portion, and wherein the storage device further comprises:
a tubular shaft extending from the opening in the storage device for receiving from one of the one or more cavities a selected bit of the one or more bits, wherein the tubular shaft defines an interior portion having a plurality of lands corresponding in number to the plurality of sides of the base portion of the one or more bits, the interior portion having an entry end proximate to the opening in the storage device, and an exit end opposing the entry end, and wherein the lands are smaller at the entry end than at the exit end, and substantially conform to the shape of the base portion of the selected bit at the exit end; and
a locking mechanism for securing the selected bit at the exit end of the tubular shaft.

13. The storage device of claim 1 wherein the one or more storage items comprise one or more bits, and wherein the storage device further comprises:
a tubular shaft extending from the opening in the storage device for receiving from one of the one or more cavities a selected bit of the one or more bits;
a passageway defined within the tubular shaft for facilitating travel of the selected bit from the opening in the storage device to an end of the shaft opposing the opening;
a locking mechanism for securing the selected bit at the end of the tubular shaft opposing the opening at an end of the tubular shaft; and
a ratchet integrated to the storage device between the receiver and the tubular shaft for controlling the rotational direction in which torque is transferred between the receiver and the tubular shaft.

14. A multi-bit screwdriver comprising:
one or more bits, each of the one or more bits defining a base end and a head end, the base end defining at least one surface extending longitudinally along the base end, the head end being configured for engaging a fastener;
a handle defining a passageway extending longitudinally along the center of the handle, the handle further defining one or more rows of one or more cells extending radially from the passageway, each cell being configured for holding a respective cartridge configured for holding a respective one of the one or more bits, each cartridge being further configured for radially sliding toward the passageway until the bit held by the cartridge is aligned with the passageway, each of the one or more bits being sized for sliding along the passageway;
a tubular shaft extending from the handle, the shaft defining a proximate end proximate to the handle and a distal end distal from the handle, the shaft including a barrel and a sleeve slidably fitted about the barrel, the barrel defining a hollow cylindrical space aligned with the passageway of the handle for facilitating sliding of a bit along the hollow cylindrical space of the barrel, the barrel including at least one land extending longitudinally along the interior of the cylindrical space, the at least one land corresponding to the at least one flat surface of the base end of a bit, the land being narrow in cross-section at the proximate end of the shaft and continually expanding in breadth toward the distal end of the shaft;
at least one cut-out defined at the distal end of the barrel;
at least one leaf spring defining a first end and a second end, the first end being attached to the barrel;
at least one locking block attached to the second end of the leaf spring, the at least one locking block being aligned for insertion in the at least one cut-out;
a coil spring positioned between the handle and the sleeve for biasing the sleeve in a distal position away from the handle,
wherein, when the sleeve is in the distal position and a bit is positioned in the distal end of the shaft, the leaf spring biases the at least one locking block into the at least one cutout against the base end of the bit to lock the bit in the distal end of the barrel, and
wherein, when the sleeve is moved toward the handle, away from the distal position, and a bit is positioned in the distal end of the shaft, the leaf spring allows the at least one locking block to moves away from the at least one cutout and away from the base end of the bit.
